(19) United States
(12) Patent Application Publication
(10) Pub. No.: US 2011/0302397 A1
(43) Pub. Date: Dec. 8, 2011

(54) Method and Apparatus for Improved Secure Computing and Communications

(76) Inventor: Joseph Mitola, III, Gainesville, FL (US)

(21) Appl. No.: 13/084,835

(22) Filed: Apr. 12, 2011

Related U.S. Application Data
(60) Provisional application No. 61/323,097, filed on Apr. 12, 2010.

(51) Int. Cl. G06F 9/38

(52) U.S. Cl. 712/241; 712/E09.045

(57) ABSTRACT

A computing and communications system and method may comprise a primitive recursive function computing engine including an instruction set architecture prohibiting loop operations that continue for an indefinite time. The system and method may further comprise the instruction set architecture comprising system identifiers selected from a group comprising things, places, paths, actions and causes. The instruction set architecture may comprise organizing at least one data thing into a processing path to be acted upon by an action. The instruction set architecture may comprise defining a processing element as comprising an input interface configured to receive a data thing into the processing path; a processor in the processing path configured to perform the action on the data thing; and an output interface configured to receive a result of performing of the action on the data thing configured to provide the result as an output of the processing element.

### CROSS-REFERENCE TO RELATED APPLICATIONS

The present application claims priority to U.S. Provisional Application No. 61/323,097, filed on Apr. 12, 2010, entitled INHERENTLY SECURE COMPUTING AND COMMUNICATIONS, the disclosure of which is hereby incorporated by reference.

### FIELD OF THE INVENTION

The disclosed subject matter relates to a computer and computing architecture for computing and communication use and particularly to a more secure architecture employing primitive recursive functions.

### BACKGROUND

Most modern information systems including computer data, instruction set architecture (ISA), communications, and the hardware-software networks on which they are based are founded on the Turing model of computability (TC) with its infinite tape on which to write data and its infinite looping abilities by which to compute recursively all of the natural numbers and related arithmetic and logic.

Godel proved two incompleteness theorems regarding any such recursively enumerable system of axioms and deductions T, showing that T either is incomplete (some true sentences cannot be included in T) or inconsistent. Kleene used Godel's theorems to prove that the Halting Problem is undecidable for TC. Specifically, there can never be a conventional computer program that can examine an arbitrary TC program and decide accurately whether it will even return an answer or not.

TC computes the general recursive functions (“GRF”), which are “partial” because for most expressible procedures a GRF will never terminate. Therefore, TC computing processes and stored data do not “die” naturally but rather consume unboundable space-time computing resources. Self-referential constructs such as the previously postulated self aware operating systems (“SAOS”) are particularly flawed. Kleene proved such SAOS to perform unboundable computing, and this mathematical reality is the mathematical foundation of malware, particularly in Internet class (exascale) collections where people cannot manually examine every piece of code or data.

Thus via Kleene-Godel, all of conventional computing is fundamentally flawed: even the postulated conventional SAOS is either incomplete or inconsistent and thus is fundamentally uncontrollable and fundamentally insecure.

An improvement in secure computing and communications, therefore, is needed.

### SUMMARY

A computing and communications system and method may comprise a primitive recursive function computing engine including an instruction set architecture prohibiting loop operations that continue for an indefinite time. The system and method may further comprise the instruction set architecture comprising system identifiers selected from a group comprising things, places, paths, actions and causes. The instruction set architecture may comprise organizing at least one data thing into a processing path to be acted upon by an action. The instruction set architecture may comprise defining a processing element as comprising an input interface configured to receive a data thing into the processing path; a processor in the processing path configured to perform the action on the data thing; and an output interface configured to receive a result of performing of the action on the data thing configured to provide the result as an output of the processing element.

The instruction set architecture may comprise defining an information processing cell utilizing a plurality of processing elements. The processing path may be uni-directional. The instruction set architecture may comprise organizing the processing cells into a parallel pipelined arrangement. The processor may comprise a memory based transformation unit. The memory based transformation unit may comprise a lookup table accessed according to the content of the data thing. The instruction set architecture may further comprising utilizing a compact markup notation to define the roles of things, including notations including enclosing the type of thing within symbols defining the role of the thing. The notations may comprise (thing), [place], {path}, /action\ and <cause>.

### BRIEF DESCRIPTION OF THE DRAWINGS

For a more complete understanding of the present invention, reference is made to the following detailed description of exemplary embodiments considered in conjunction with the accompanying drawings, in which:

FIG. 1 shows a hierarchy for an improved secure computing and communications (“ISC2”) system;

FIG. 2 shows a partly schematic and partly block diagram form of a an information processing system made up of constituent information processing overlays including information processing cells, according to aspects of the disclosed subject matter;

FIG. 3 shows a schematic and block diagram form of a processing element, according to aspects of the disclosed subject matter;

FIG. 4 shows a schematic and block diagram form of an information processing cell, according to aspects of the disclosed subject matter;

FIG. 5 shows a schematic and block diagram form of an information processing overlay, according to aspects of the disclosed subject matter;

FIG. 6 shows a partly schematic and partly block diagram form of a processing flow, according to aspects of the disclosed subject matter;

FIG. 7 shows a schematic and block diagram form of a portion of an information processing cell, according to aspects of the disclosed subject matter; and

FIG. 8 shows a schematic and block diagram form of a portion of an information processing cell, according to aspects of the disclosed subject matter.

### DETAILED DESCRIPTION OF THE EXEMPLARY EMBODIMENTS

According to aspects of embodiments of the disclosed subject matter, applicant proposes novel and fundamental mechanisms for representing and performing computing and communications via finite, controllable and therefore secure mechanisms from the hardware to the presently proposed self-aware operating system SAOS, i.e., a newSAOS (“NSAOS”), including networks, applications and users. These mechanisms include fundamentally integrated initiation-operation-extermination (birth-life-death) processes for the physical security of computing-communications facilities, comprehensive personnel security, comprehensive information security (information representation, combinatorial logic, iteration, and secure creation of processes and data), and communications security (when information is stored, prepared for transmission over space-time, transmitted, received, and internally transformed) with guided hardware-software co-evolution as inextricable parts of the resulting secure information system. Co-evolution allows software to using established machine learning tools to update the software to reflect the ways in which users operate the system, at the same time updating the memory based transforms and other configurations of thing, place, path, action, and cause so that the hardware instruction set architecture co-evolves with the software.

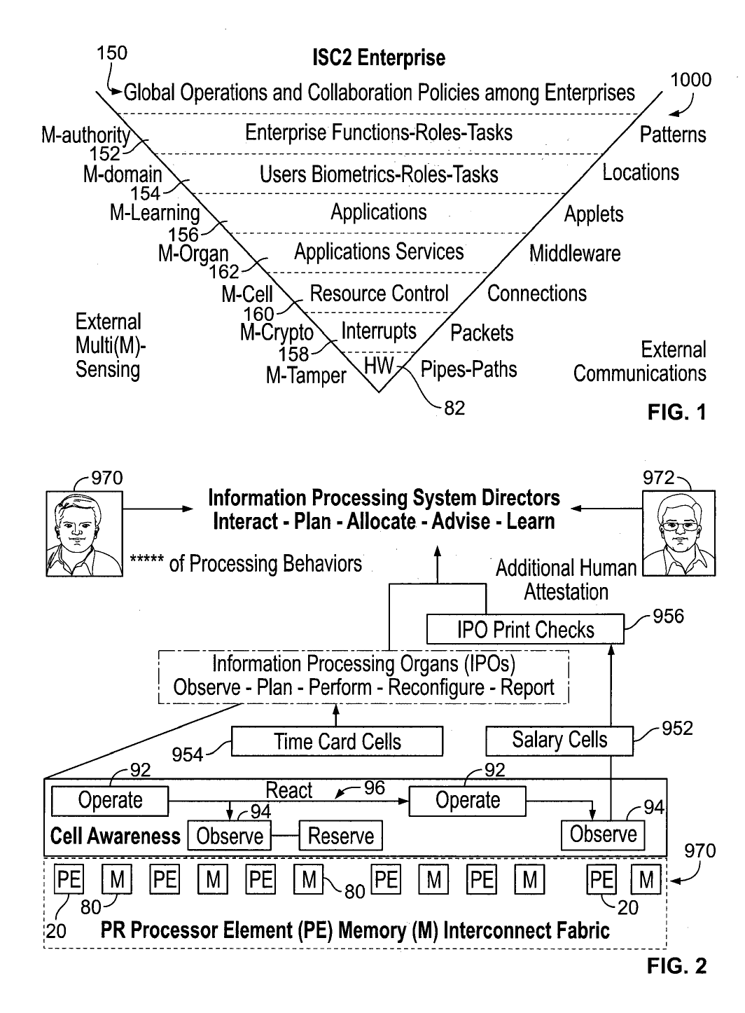

Briefly, aspects of embodiments of the disclosed subject matter provide for an improved secure computing and communications (“ISC2”) system 1000, a hierarchy for which can be seen in FIG. 1. An improved secure computing and communications (“ISC2”) system 1000 can be used to reshape computing and communications from general recursive functions (“GRFs”) to a tightly bounded subset (“TBS”) of the primitive recursive functions (“PRFs”), and without indefinite time loops, which can provide a complete formalization of finite arithmetic and logic, provably consistent, and sufficient for practical computing such as word processing, financial transactions, and a myriad of signal processing applications like radio and radar.

To secure communications without securing computing is to secure nothing. Therefore ISC2 according to aspects of the disclosed subject matter restructures both computing and communications (“C2”) according to TBS PRF principles so that both can be considered provably secure in which computing and communications elements of ISC2 can be composed to form systems from embedded controllers to exascale constructs, i.e., high performance networked computing systems for more secure Internet usage, as an example.

According to aspects of embodiments of the disclosed subject matter, any practical finite subset of the GRF may be synthesized via external control over TBS PRF computing according to aspects of embodiments of the disclosed subject matter. Therefore ISC2's systems 1000 employing strict PRF principles can cause all data to decay when not in use. Thus, aspects of the disclosed subject matter include an instruction set architecture (ISA) and architecture mechanisms to guarantee data decay. To secure computing without securing communications is to secure nothing.

Also, according to aspects of embodiments of the disclosed subject matter, the representation, storage, distribution, and manipulation of data/information via computing and communications systems, including measures to limit and control who can access and control the computing and communications processes are presented. The disclosed subject matter can use authorization, obfuscation, and non-repudiation mechanisms to accomplish such architectural goals. The existing art fails to recognize the untoward aspects of computing using GRFs. Neither has the narrowing of hardware, e.g., ISAs, or protocol stacks from GRF to PRF been appreciated.

The art fails to appreciate the need for mechanizing the intentional systematic yet reversible degradation and destruction of data and processing capabilities as a mechanism for establishing security in either computing or communications, as is accomplished according to aspects of the disclosed subject matter. The art also fails to recognize the necessity of securing both information processing and communications simultaneously and continuously, e.g., beginning with robust cryptographic representation of information in the ISAs and proceeding through the life of the data as information interpretable only via externally supplied entropic “data energy” which permits retaining data for a brief period of time or computing steps, that otherwise is also cryptographically protected before autonomous decay.

PRF mediation of human interaction with such information; and random noise in physical and logical manifestations that remains after the data support from externally supplied data-energy license has been terminated or reduced below acceptable levels, which, according to aspects of embodiments of the disclosed subject matter naturally destroys itself by its interactions with self-generated noise in the smallest element of the system, the PE, which can be, amplified and focused onto the memory based transform e.g. via micro-scale batteries on-board each chip so as to substantially limit the life of recoverable data to within relatively short specified bounds, also being protected via tamper resistance mechanisms.

According to aspects of embodiments of the disclosed subject matter an Information Processing System (“IPS”), such as an ISC2 information processing system (“ISC2-IPS”) 1000 can include information representation, block 100 of FIG. 4, and information processing, block 300 of FIG. 4. Information representation 100 can be distributed into collections of processing elements PEs 20 in FIG. 2 according to the system identifiers of a comprehensive organization plan (COP), loosely analogous to DNA in living organisms. According to aspects of embodiments of the disclosed subject matter, for purposes of the present application, the system identifiers or COP are used as a shorthand for source information, structural information and regulation of the operation of elements of the computing and communication architecture disclosed in the present application, and as is further described herein. The information processing described herein follows the instructions, structures and regulations defined by, and, thus, imposed by the system and processing element system identifier template(s), such as the instructions to carry out an action, e.g., to multiply one number times another, as further defined below. Through the use of a cognitive linguistic machine language (“CLML”), along with the system identifiers, a virtual machine (“VM”) can be realized which can organize the things and interactions of the outside world in a way that computer scientists and programmers may readily understand.

According to aspects of embodiments of the disclosed subject matter system identifiers in a COP at the system 1000 level can include a system 1000 in which, e.g., S is a (thing), which may in turn be composed of other (things) that interact via [places], {paths}, /actions\ and <causes>. Generally, everything is a thing (which can be abstract or concrete). A place is a feature of a reference thing. A path is an ordered sequence of connected things, such as places. An action is the behavior of things in motion, e.g., along a path. A cause is a role of a thing interacting with other things. The system identifiers can be understood to be a listing of parts and allowable roles and interactions among such parts, and can be used to describe how to build a system from such parts.

System identifiers aggregated into a COP can be expressed by a compact markup notation (“CMN”), which can, e.g., define the roles of “things.” Thus parentheses denote a (thing), lower case brackets denote a [place], upper case brackets denote a {path}, forward slash and back slash denote an /action\, and less than/greater than denote a <cause>. For (things), every(thing) is an indexed (thing). In addition, every system 1000 is, therefore, finite and all parts are known to the identity/self of the system 1000. With regard to [Places], any(thing) may exhibit [places], with which the referenced (thing) interacts, e.g., with another (thing(s)), including particularly mobile (things) such as (data). Regarding {Paths}, this can include a sequence of [places] defining the {path}. An /Action\ can include, e.g., a (thing) moving down a {path}, i.e., a movement /action\, or a number (thing) being multiplied by another number (thing), i.e., a multiplication /action\, i.e., /A*B=C\. With respect to a <cause>, any(thing) that <initiates>, <influences>, or <terminates> an /action\ is a <cause>.

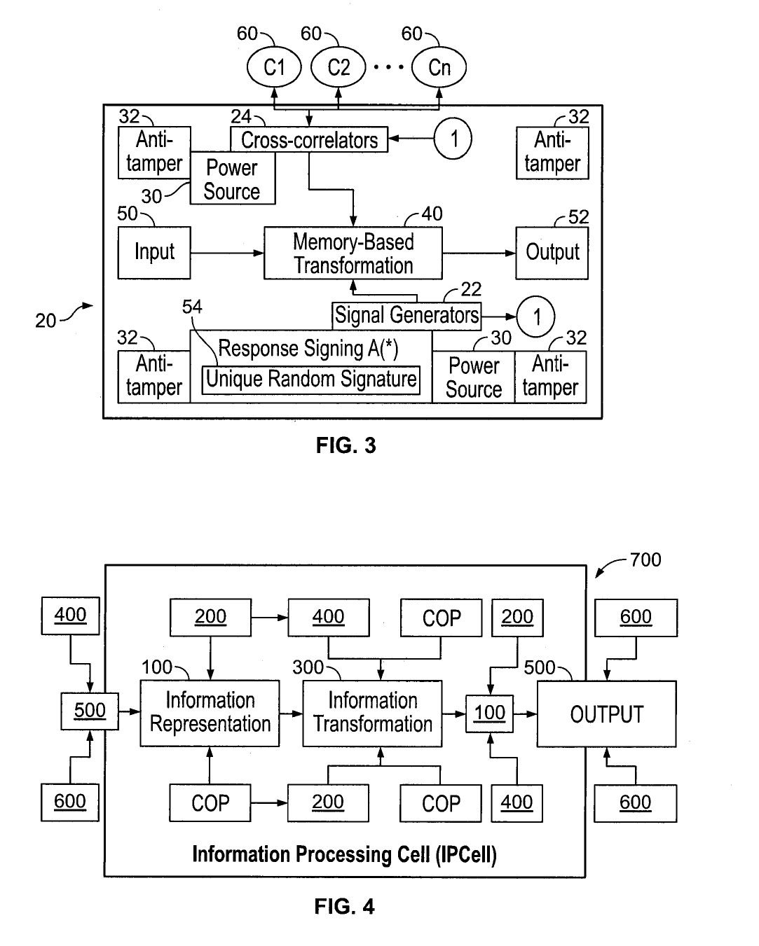

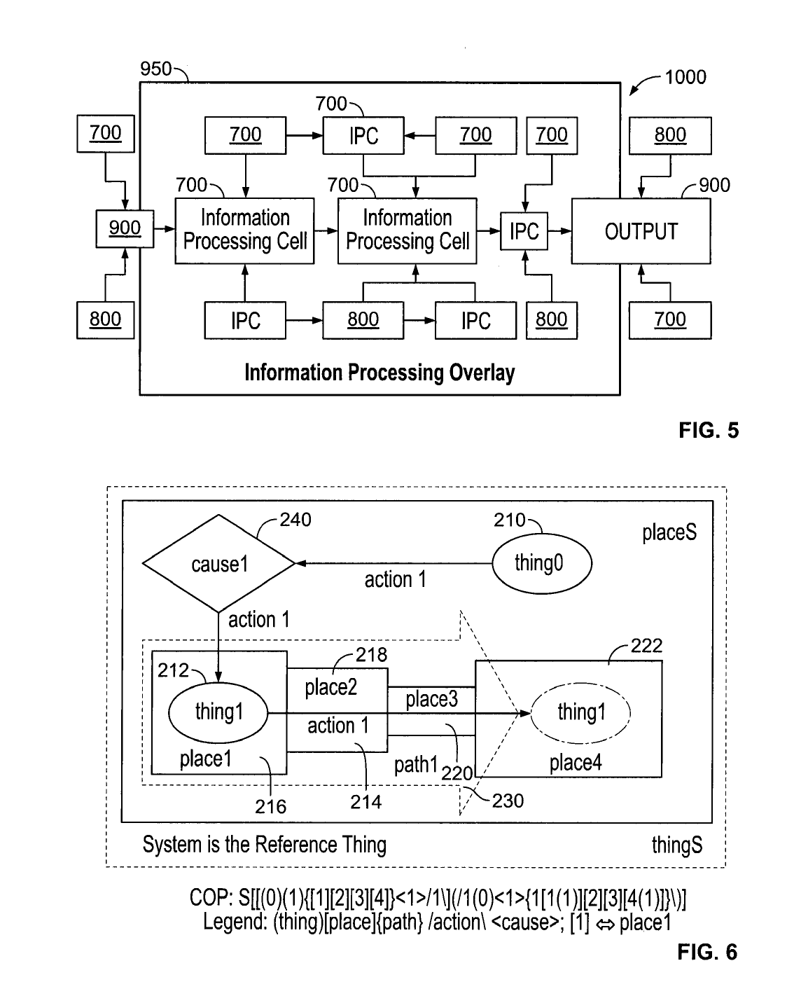

The disclosed subject matter in one embodiment can comprise a processing element 20, as illustrated in FIG. 3, which may include a cryptographic reference signal generator 22, a co-channel signal generator 24, cryptographic signal mapping units [between the signal generators and cross correlators of FIG. 3 via the jumper circles (1) that avoid drawing this arrow across the arrow between memory based transformation and the output frame], an embedded power source (e.g. a printed battery) 30, anti-tamper sensors—actuators 32, and a memory based transform (MBT) 40, e.g., including a lookup table (not shown), e.g., utilizing a 10 bit address lookup, allowing for about 1 MB of memory (lookup table) locations. The MBT may be incorporated in an on-chip 1K×M memory, where M may be, e.g., one byte of data, making 1K×M equal a 1K×8 bits of on-chip memory. There is no hard drive in the system 1000 as shown in FIG. 5. Encrypted backup hard drives (not shown) may be used for data and system storage and the data hard drive may be separate from the system hard drive, if used. In an embodiment, there may be no such hard drives.

The processing element 20, may also include an input frame 50, which is a collection of data, the presence of which causes information flow through the MBT to the output frame. [This input is called a frame using standard telecommunications systems engineering language for a set of data with an associated logical test (predicate) that determines that a new frame is present] and an output frame [which is present when the processing element has completed processing the input frame] 52, for passing data into and out of the processor element 20. Also, a unique random signature (“URS”) 54 is embedded into the response signaling generator and must be included and must have a previously defined mathematical relationship to all of the other processing elements and data exchange or communications paths in the system.

A cluster of other PEs 20 acting, e.g., as signal sources for correlators 60 (C₁, C₂ . . . Cₙ) also must be included in order to provide signals to any given PE indicating that adjacent PEs are present, providing self-awareness. A processing element (“PE”) 20 may comprise a self-aware processing element (PE) 20, wherein, each such PE 20 can attest adjacent PEs 20 to itself and each other per system identifiers for the 1000 by measuring the degree of correlation of incoming signals C1 . . . Cn and by providing a copy of the PE's own generated signal from 22 to physically or logically adjacent PEs via paths 60.

A missing PE 20 may be non-functioning or mal-functioning for a short time without effect to the system 1000, and errors may be self-corrected by the PE because of redundancy coded into the MBT. For example, a multiplicity of data reflecting error-free data and data with one bit in error may lookup exactly the same result from the memory of the MBT, thus correcting the single error of the input frame. More complex errors may be corrected insertion of correction bits into the distributed clusters of PEs by the information processing overlay operating in an error recovery mode. However, multiple missing/malfunctioning PEs 20 or a missing/malfunctioning PE for a time greater than some threshold T can cause many memory errors.

Multiple attestation (e.g., of PEs 20 to each other) occurs via the operation of the signal cross-correlators 60, e.g., at the receiver in each PE 20. A multiplicity of PE 20 signals can be coded to cancel errors via appropriate definition (via the COP) of codes within a cluster. In a tutorial embodiment, there could be only two PEs connected to each other via path C1. If the binary signals from both PEs are identical, say 101101, then the cross-correlator registers 100% identical bits and passes the bits to the MBT where the incoming signal 101101 is added to the generated signal 101101 to yield 000000, which when added to the memory changes nothing. If there is no such external PE, then the input is 000000, so the correlation is zero. This lack of correlation is recognized as a failure of attestation by the PE.

In addition, the input 000000 is added to the PE's own signal 101101 to add the bits 101101 into the MBT. This modifies memory in a predictable way. If the overlay process is invoked very quickly, then the contents of the MBT may be recovered by presenting 101101 into the input frame with an input code that signals to the MBT to add the input frame to its memory. This operation results in 101101 added to 101101 returning the memory to its original condition, which could be 110001, or any other six bit binary pattern. In practical embodiments, the size of the bitstreams being correlated would be 1024 bits or more. In binary addition of both 1024 bit signals, the result is 1024 sequential zeros, added to memory preserves memory. Loss of multiple PEs 20 or one PE 20 for a time greater than the threshold T can induce error in memory, i.e., in the memory based transformation (“MBT”) 40 in the PE 20.

An instruction set architecture (“ISA”) can be coded in the memory 40, e.g., as a lookup table, e.g., using 10 bits to define a 1K×M memory address space. Memory errors destroy ISA functionality by changing the lookup table from the state coded by the COP or learned by the system to a pseudo-random state with functionality degraded or destroyed, thus protecting the MBT ISA as proprietary information. The system 1000 may employ, such as death of data by default, such that each PE 20, IPCell 700, shown in FIG. 4, or IPOverlay 950, shown in FIG. 5 destroys all data if, e.g., another PE 20 or IPCell 700 is not detected as being present, when it is supposed to be present, for a time greater than some threshold T.

Thresholds T may be defined in the COP with different values for PE, for clusters of PE connected via channels C1 . . . Cn, for different overlays, or for the system as a whole, providing persistence for some less sensitive elements and providing near immediate destruction for other, e.g. more sensitive elements of the system or fields of data stored in the MBT.

The Instruction Set Architecture (ISA) can synthesize the VM of the system 1000, e.g., by distributing (things) across available PEs 20 according to the system identifiers of the COP and by utilizing pipelining of data and processing through the resulting distributed processing cells 700 containing PEs 20, in order to achieve information processing actions. With the memory based transformation (MBT) units 40 in the PEs 20, the ISA can be coded in memory, such as through distributed lookup tables. For example, part of the COP containing the ISA system identifiers codes the function of the distributed lookup tables, e.g., multiply A*B, etc.

PEs 20 may destroy ISA and data when the PE 20 is removed from the system 1000, thus protecting user data. The MBTs 40 can realize VM actions on VM things, through table lookup with optional optimization circuits. For example, IEEE floating point arithmetic conforms to a well-defined standard, so a floating point pipeline block could be provided in a PE in lieu of the MBT. Such a PE would compute, for example, 64 bit floating point arithmetic with less energy and more quickly than a cluster of PE's configured to perform IEEE floating point standard arithmetic. In addition, the loss of such a chip would not result in the unauthorized recovery by a third party of any data processed by the PE.

Ten bits of instruction and data addresses can provide 1K of resulting values stored in the 1K address locations in an MBT unit 40. The system identifiers of the system 1000 in each PE 20 and IPCell 700 can define a multi-PE 20, i.e., multiple MBT 40, such as an, MBT configured for memory space (ME), an MBT configured for the frame-to-frame interconnect function (IX) and for logical, arithmetic, or other processing functions, all via appropriately configured PEs 20, IPCells 700 (FIG. 4), IPOverlays 950 (FIG. 5) and groupings of IPOverlays 950, i.e., a system 1000.

An architecture for the improved secure computing and communications (“ISC2”) system 1000, can include a method and system for achieving more secure communications and more secure computing simultaneously. The system 1000 architecture may include multiple orthogonal attestation and verification, extermination of data (and functionality) by default, complete system identifiers, e.g., including in the smallest independent information processing (IP) modules, e.g., processing elements 20 (“PEs”). Human operators can be considered as explicit, controlled parts of the system 1000.

The system 1000, via machine learning (“ML”) can program itself according to the allotted and permissible behaviors circumscribed by system identifiers of the system 1000 aggregated into the COP. A copy of the COP can be embedded into each IP cell 700, IPOverlay 950, and grouping of IPOverlays 950 so that all system components have the identical comprehensive organization plan, following it according to the distribution of processes, via the particular IPOverlay 950 that allocates functionality to individual processing elements 20.

According to aspects of embodiments of the disclosed subject matter, as illustrated, e.g., in FIG. 1 the system 1000 may include a system 1000 enterprise attestation scheme 154 shown also in FIG. 2 as persons 970 and 972 mutually and independently attesting decisions to the system via multiple attestation and verification schema. At the lowest system 1000 level, e.g., the hardware 82, via data frame interrupts 158, e.g., on chip on a semiconductor integrated circuit implementing the system 1000 architecture, each processing element 20 may function with several other PEs 20, e.g., in a cluster of multiple PEs20 mutually attesting via channels C1 . . . Cn as shown in FIG. 3, most of which PEs 20 may be used to attest to the behavior of the others without which each will destroy itself per sensors 32, correlators 60, and system identifiers of the system 1000.

At the middle layers labeled as 160, 162, and 156, the system 1000 can be self-aware, e.g., applying 80% of the processing resources to verify existence and consistency of the identity of the system, e.g., per the system 1000 system identifiers and the realized VM. At higher layers labeled as 154, 152, and 150, the system 1000 can determine a-priori exceptions and can learn human behavior details and exceptions. At the highest layer labeled as 152 and 150, the system 1000 system identifiers can act as a policy language, which can be enforced at the level of the smallest data element and comprise a collection of related elements to defeat unauthorized retrieval or slow leaking of data from the system over time.

In regard to the IPCell, 700 in FIG. 4, multi-attestation, each cell comprising multiple PE 20's connected via channels C1 . . . Cn into clusters of multiple PEs 20 containing at least one complete copy of the system 1000 system identifiers, e.g., the COP in a system 1000 identifiers cluster 210 located in the blocks 210 of FIG. 4, labeled COP, a cluster of the IPCell 700. System 1000 identifiers, copies of the COP, may be cryptographically signed and consistent with the unique random signature 54 of each PE 20, e.g., via greater than 90% correlation with each other, e.g., as continuously measured via the PE 20 correlators (60 (C₁, C₂ . . . Cₙ) in the clusters 200, 300, 400, 500, and 600.

System 1000 identifiers correlation failure can be utilized to cause an IPC 700 to destroy itself. Thus, an IPCell 700 can be considered to be comparable to an operating system (“OS”) thread. IPCell 700 adjacency can be sensed via interface elements 600, shown in FIG. 4. The system 1000 may be constructed to put a (Self) pointer in the system 1000 identifiers that causes the IPCell 700, e.g., defined by input/output interface inputs/outputs 500, shown in FIG. 4, to support adjacent IPCells 700 having similar pointers.

An example of a system 1000 (termed system “5”) in FIG. 6 can have an S system 1000 identifier COP, which may include, as an example, S being defined by “[[things-of-S] how-to-build-S].” For example, “S [[(0)(1){1[1][2][3][4]}<1>/1\] . . . ]” would define S, i.e., the thing (S) to contain (thing0)=(0) at FIG. 6, 210 and (thing1)=(1) at FIG. 6, 212. As denoted, S can have {path1} 230, e.g., through four places [place1] . . . [place4]=[1][2][3][4], 216, 218, 220, 222 respectively. Also S can contain a <cause1> at 240 and an /action1\ at 214. Action1, /1 . . . \ in S can also be considered to be a (thing). According to the expression “/action1\=(/1(0)<1>{1[1(1)][2][3][4(1)]}\)” abbreviated in the Legend of FIG. 6, the (thing0)<causes> (thing1) go from [place 1] to [place4]. The <Cause> <1> of the FIG. 6 action /1\ serves as an on/off gatekeeper such that thing (0) initiates /action1\ when it interacts with <cause1> at 240.

Each IPCell 700 can have input/output interfaces, e.g., as defined as being within the IPCell 700 input 500 on the left of FIG. 4 and output 500 on the right of FIG. 4, such that within the input/output interfaces 500 IPCells 700 are isolated from other IPCells 700. Clusters 500 are not simple input output frames, but rather can be used to transform stimuli received from the exterior of the IPCell 700 into derivative patterns of data. Anything that is not explicitly recognized according to the COP expressed in the specific IPCell 700 is ignored, producing no response within the IPCell 700. This behavior mitigates denial of service attacks and assures that malicious agents cannot be leaked into an IPCell 700, e.g. via malicious use of legitimate bits.

Interface monitors 600, shown in FIG. 4, can mediate IPCell 700 to IPCell 700 information flow by expressing the aspects of the COP that are relevant to the specific IPCell 700, and by configuring the inputs 500 to allow only a very limited list of previously defined items or ranges (e.g. of numbers) to cause movement of data from the input gate keeper 500 into the information representation 100, processing, i.e., information processing cell 300, or output representation PE 20 cluster 100 of FIG. 4.

The IPOverlays 950 can control the interface monitors 600 by expressing data from the COP into the cohorts according to the functions allocated to the IPCell 700 top down by the System 1000 in FIG. 1 via the IPOverlays 950 of FIG. 5. A system 1000 may consist of one or more IPOverlays 950 as specified in the COP top-down, and as feasible to populate based on PE 20 availability bottom-up. Coordination of functions, e.g. distributing parts of a database across multiple IPCells 700 with aggregate record indexing across the fields of a record can be utilized.

The system 1000 of FIG. 1 may include an information processor overlay “IPO,” i.e., “IPOverlay,” 950, shown in FIG. 5, which, according to aspects of embodiments of the disclosed subject matter, may operate through the expression of higher levels of system 1000 identifiers included in the COP. The system 1000 IPO 950 may allocate PE 20 resources, e.g., to IPOverlays 950 with their associated overlay interfaces 900 and overlay interface controllers 800; and thus down to multiple IPCells 700 subordinate to these IPO level constructs including flowing down to input/output interfaces 500, and interface monitors 600 at the IPCell 700 level, each of which are comprised of multiple clusters of PEs 20 that mutually attest via communications channels C1 . . . Cn and that process distributed data stimuli into responses via their input and output frames 50, 52.

IPOs 950 may grow and shrink as system 1000 resources are used, e.g., typically growing when 50-75% capacity has been used up and shrinking when only 25-50% of available capacity is needed, according to the behaviors specified in the system 1000 COP. IPOs 950 may employ macro-scale sensing (audio, video, thermal, power), e.g., of people, things and places, such as machines, rooms, offices, power systems, storage networks, etc. in order to protect the system 1000 (“self”) from external threats. IPOverlays comprising a system 1000 may contain long-haul communications such as Internet connections, satellite connections, or fiber optic connections across long distances.

According to aspects of embodiments of the disclosed subject matter, the system 1000 of FIG. 1 can include information representation hardware, software, and communications mechanisms, such as are illustrated at 100 in FIG. 4 that continuously represent information and obfuscate it, can be coded cryptographically and simultaneously coded for error resiliency such as by forward error control coding that embeds redundancy in the (data) bits, e.g., in the MBT 40, and in other aspects of the system 1000 such as the COP. In addition, information representation mechanisms 100 with signal generators 22 can be used to regularly impart quantities of binary pseudorandom noise to all such information representations (“data”) to yield a sequence of noisy information representations over time such that the information representation (“data”) internal to and external to a PE 20 no longer is recoverable by other than synchronized cryptographic means, after a sufficient series of such operations to impart noise, informally causing the death of the data on precisely defined and controllable time scales.

Considering a given MBT 40 as defined to perform an instruction 110001. The semantics of this instruction could be that the leading two bits constitute the operations code 11, while the remaining four bits are local data. By installing the 8 bit value 00000001 at location 0000110001 of a 10 bit MBT 40, the MBT 40 lookup would return the nibble 0001 for the operand 0000. By installing the 8 bit value 00001101 at the location 110011001, the four bit operand 1100 would yield the value 1101. The additional 256 values associated with the binary numbers between 0000110001 and 1111110001 which represent an argument (first 4 bits), op code (next 2 bits) and operand (final 4 bits), are associated with values between 00000001 and 00010000 respectively. This functionality for the MBT 40 provides this operations code 11 with the semantics of “add one immediate” or “increment the argument”.

When random data such as 101101 is added to an instruction such as 1100001 in binary (exclusive OR arithmetic), the resulting pattern 011100 is meaningless because those locations in the MBT 40 are set to contain null data of some sort. The value of the MBT 40 at this meaningless position in MBT 40 memory look up table could be a previously defined null pattern such as 000000, or could be some random set of bits added via the cross-correlator and signal generator of the PE 20.

The system 1000 can include the related hardware, software, and communications error detection and correction mechanisms, such as are illustrated as 200 in FIG. 4, which when applied in appropriate cohorts (multiple independent cooperating physical processes), can be utilized to recover functionally useful data from data to which quantities of noise have been and are being imparted. For example, to respond to recover the data, the random bits added to destroy the data could be regenerated from the unique random signature 54, and could be interpreted via the COP to recover system 1000 timing, and to thereby establish exactly which bits had been written onto the MBT 40 memory and in which order. Because of the well-know properties of adding identical bitstreams to each other, the result would be the recovery of data that had been previously destroyed. For non-commercial applications, the destruction process could be so extensive as to preclude such recovery processes, even by recovery of the unique random signature 54 in the IPCell 700 of an appropriate IPOverlay 950.

The system 1000 of FIG. 1 can include the related hardware, software, and communications sequential and combinatorial mechanisms, such as are illustrated as information transformation block 300 in FIG. 4, to perform sequential and combinatorial logic and other linear and nonlinear transformations on noisy data representations, e.g., received from information representation block 100 in FIG. 4, in order to realize arithmetic and logical transformations of single and multiple quantities of noisy data when assisted by noise and atrophy cancellation cohorts 200. The information transformation block 300 mechanisms can continually add noise to the transformations themselves, such that functions atrophy, if not used, informally causing the loss of transformation capability in block 300 after a sufficient series of such operations, informally can cause the extermination of the functionality of the IPCell 700.

This can occur when a sufficient number of MBT's 40 in a sufficient number of clusters of PEs 30, implementing IPCells 700 have been sufficiently overwritten. The COP can also adjust the resiliency of the IPCell 700 via parameters that distribute processing load and memory representations either for greater or lesser privacy or for greater or lesser reliability and robustness, or to maximize or minimize other aspects of the system 1000 as defined at design time, or as co-evolved via machine learning in the field as authorized by multiple attestation of hardware and authorities of the ISC2 Enterprise 1000 via layers 150 through 158 and 82 in FIG. 1.

The system 1000 can include the related transformation restoration hardware, software, and communications mechanisms represented as blocks 400 in FIG. 4. When applied with appropriate cohorts 200 these mechanisms 400 can temporarily restore transformation processes to forms with sufficiently few errors to allow effective transformation when operating as a whole, sustaining the strength of the processing by the application of energy from multiple associated sources, such as via correlation energy in the correlators 60 of PEs 20 interconnected among blocks 100, 200, 300, 400, and 210 of FIG. 4. The presence of such correlations cancels errors, providing the support from attestation of monitors 400 for information representation 100 and processing 300.

The system 1000 can include the related hardware, software, and communications mechanisms, as illustrated as input/output interface blocks 500 in FIG. 4, which can be used to access and select among subsets of noisy data to perform translations of intended subsets of that data. This can be used to define the boundaries of information processing cells 700 contained therein. As defined by the data input/output interfaces 500, the paths for accessing that data and the qualities of that data can be continuously and independently represented cryptographically to integral information processing cell 700 monitoring processes, by the distribution of interconnections among clusters of PEs 20 and by their synchronization and mutual attestation operations via PE 20 channels C1 . . . Cn.

Blocks 500 can allocate codes to their constituent PEs 20 that generate response signaling indicated as A(*) in the PE 20 of FIG. 3. Response signaling can abstract a key from the unique random signature 54 using existing security protocols such as the Trusted Computing Module (TCM) or the GSM signed response from the GSM cryptographic protocol.

For IPCell 700 level self awareness, and data transiting such input/output interfaces 500 can be subject to comparison to a dynamically changing template(s), such that data not conforming to such a input/output interface-transition template(s) can be immediately encapsulated by transfer via PE 20 input frame between a PE 20 in block 600 and the associated PE 20 in block 500 that detected the failure to conform to the template. The encapsulated block may be quarantined in block 600 or released outside of the IPCell 700, such as through the output input/output interface 500 to some other PE 20 in some other IPCell 700 or vertically upward into the IPOverlay 950 layer for analysis; or the offending data may be destroyed within the information processing cell 700.

The system 1000 can include the related hardware, software, and communications mechanisms, such as are illustrated as block 600 in FIG. 4, which may, when acting with appropriate interface cohorts 400, transform cryptographic forms of cell level self awareness, e.g., as developed in pores 500, into forms suitable for autonomous control of the information representation. This may include, e.g., moderating processes within a given input/output interface 500 and mediating process that cross data input/output interfaces 500. Mediation may occur via functions distributed into the PE's 20 that are organized into a cluster(s) to realize a cohort 400. The MBTs 40 in these lower level PEs 20 can be programmed to add pseudo-random bits onto blocks flowing through the system 1000, i.e., in an IPC 700, to either mask or reveal the contents of functional blocks. The subordinate PEs 20 can share the same unique random signature 54 of all of the other PEs 20 of the system, so their addition of random bits will tend to obscure or to reveal the content according to the plan of the COP.

The interface clusters 400, 600, 700, and 800 can be used to allocate specific PE's 20 to originate and share among all other such blocks a flow of timing in the blocks from input to output 500 and back to an inputin a succeeding IPCell 700, e.g., for update of the clock PEs 20 within clusters 400, 600, 700, and 800. Timing blocks are frames of data that express time with respect to a global system clock and with respect to local derivatives of that clock. Signal generators and correlators maintain local time by shifting bits to preserve perfect synchronization of bits on logically and physically adjacent PEs 20, e.g., via channels C1, . . . Cn.

The system 1000 at its IPOverlay 950 level of abstraction can include the related hardware, software, and communications mechanisms, as illustrated in overlay interface support blocks 700 in FIG. 5, e.g., in a so-called information processing overlay 950 scaffolding. These interface support blocks 700 are specialized IPCells that may be utilized to establish concrete, finite bounds for the serial, parallel, and systolic arrangements of IPCs 700, e.g., via tightly bounded repetition of sequential and transformational processes contained therein. The IPCells 700 may be used to monitor such repetition, e.g., for conformance to space-time-energy use, e.g., specifically shutting down elements, such as in blocks 100, 200, 300, 400, 500 and 600. when not in use.

The system 1000 can include the related hardware, software, and communications mechanisms, as illustrated as overlay monitor blocks 800 in FIG. 5. The overlay monitor blocks 800 also are IPCells specialized to monitor flows among overlays 950. In a business application, there may be an overlay 950 for entering data such as time cards, another overlay 950 for computing weekly pay based on salary and tax deductions, and another overlay 950 for printing checks. The overlay monitor blocks 800 apply COP criteria to assure that people interacting with the system are multiply attested by a token such as a credit or identity card, by a unique chunk of knowledge such as a password, by observing behavior that is consistent with the role as defined by the COP, such as time card data entry; and by an established history of face, name, keystrokes, voice, and other multiple observables, such as 154 in FIG. 1, by which the system 1000 may learn acceptable details of behavior authorized by the COP by observing the people over time.

Overlay monitor blocks 800 can consist of clusters of PEs 20 organized into information representation 100, processing 300, and interfacing functions 200, 400, and 500. The overlay monitor blocks 800 can function intuitively as information monitors to detect processes whose finite bounds or behaviors have been exceeded and to, therefore, immediately destroy the processes and related data, or, optionally, encapsulating the offending data for subsequent analysis. The overlay monitor blocks, e.g., 200, 400 also may be used to characterize comprehensively and compactly all resources within the outermost data input/output interface defining interactions with the external environment, i.e., the overlay access points 900 shown in FIG. 5.

The system 1000 can include the related interface hardware, software, and communications mechanisms, labeled as overlay 950 access points block 900 in FIG. 5, as the input/output interfaces for the information processing overlay 950 of the computing/communications system 1000 of the disclosed subject matter, to provide access to the outside world. The information processing system 1000 via its COP can characterize the space-time-energy occupancy and finite initiation-life-termination trajectory and behavioral roles of each of the hardware, software, and communications mechanisms within the system defined above, i.e., blocks 100, 200, 300, 400, 500, 600, 700, 800 and 900, including the characterization of interactions among mechanisms and across interfaces, whether authorized or unauthorized (e.g. unauthorized tampering with hardware, software, and data, either at rest in storage or in motion while being processed/communicated). The overlay 950 access points 900 monitor internal and external communications as constrained by the COP.

The system 1000 can include also related hardware, software, and communications mechanisms to compactly, continuously and intermittently characterize the space-time-energy occupancy, behavioral roles, and initiation-life-termination trajectories of the human beings associated with the information system 1000 defined above, i.e., 100, 200, 300, 400, 500, 600, 700, 800 and 900. the system 1000 can employ these characterizations according to the COP to guide system 1000 evolution. The COP defines constraints at interface points, such as 500 and 900, e.g., including the kinds of entities with which an overlay 950 may communicate, e.g. ISC2 or the Internet. If the Internet, the COP can specify exactly which exchanges are allowed (e.g. HTTP without cookies or JavaScript) and the protocol stacks that are allowed (e.g. IPv4 or v6) and the associated security protocols (e.g. certified private RSA with IPSec). The interface blocks 400, 500, 600, 700, 800, and 900 then constrain data types and flows, aggressively flushing packets and terminating connections that do not fully conform to space-time-energy (e.g. limited ports, packets, and probes), behavioral roles (e.g. data only, display only for Internet browsing), and data life cycle processes (e.g. all browsing data destroyed via MBT 40 cleansing of all IPCell 700 blocks 100, 200, 30, etc. supporting a browsing session, e.g., within seconds after the session is over).

A primitive recursive function (“PRF”) instruction set architecture (“ISA”), i.e., “PRF ISA,” can be utilized, e.g., by which information representation, e.g., in block 100 in FIG. 4, information transformation, e.g., in block 300 in FIG. 4, and input/output interfaces, such as, blocks 500 in FIG. 4, may be synthesized, e.g., by configuring the MBTs 40 of multiple PEs 20 into associated clusters, e.g., into identical stacked associative memories to perform functions of IPCells 700. Unique functionalities may be embedded into MBTa 40 to differentiate functions Functionalities may be migrated from one PRF ISA-realizing MBT 40 cluster to another, within which can reside cryptographically secure long random numbers of the unique random signature 54 embedded into each PRF ISA with its associated embedded cryptographic process, e.g., A(*), that accepts random challenges (RAND) from PEs 20 in a cluster via channels C1 . . . Cn 60 and returns signed responses (“SRES”) representing the operation A(RAND). Functionalities may impart cryptographically generated noise to the memories.

The IPCell 700 or its higher level IPOverlay 950 may cause an IPCell 700 to receive a random challenge RAND in its input 500 in order to extract attestation according to a unique random signature 54 known to the IPCell 700 or overlay 950. This challenge may be asserted for example when a PE 20 has been removed and replaced for maintenance or repair. The SRES then would be computed via A(*) and provided through the signal generator 22 via the MBT 40 to the output 53 from which the IPCell 700 or IPOverlay 950 would access the SRES via an intra-cell or intra-overlay data flow mediated by interface blocks 400, 500, 600, 700, 800, and/or 900.

Similarly, the PE 20 may employ what in communications practice is referred to as base station authentication. e.g., by asserting a random challenge RAND to the IPCell 700 to authenticate that the entity of which it is a part in fact shares the same unique random signature. Following protocols established by the commercial TCM, the RAND may be generated locally and randomly based on the PE's 20 own local signal generator 22 embedded signal clock, based on the correlation of a selected channel C1, . . . , Cn 60 clock(s), or based on some other process with naturally random components such as the ambient temperature of the chip sensed via an anti-tamper sensor.

The PE's 20 RAND therefore will be relatively unpredictable to the IPCell 700 or IPOverlay 950. If the IPCell 700 or IPOverlay 950 does not reply with a suitable SRES, then the PE 20 may initiate its own destruction, e.g., by removing access to channels 60, adding signal generator bits continually into MBT 40 memory to destroy stored data and/or stored PRF ISA and/or other data stored in the lookup table.

A PRF operating system (“PRF OS”) with associated self-inspection, self-configuring, self-monitoring, and self-repairing properties may be configured by distributing OS functions over PEs 20 embedding the PRF ISA that have been organized into IPCells 700 that cooperate as part of a larger IPOverlay 950. PRF-OS functions of detecting and responding to interrupts from external paths may be realized via such IPCells 700 in interfaces 700, 800, and 900 in which interrupts appear into PEs 20 in interface blocks 900 as input frames with associated device data.

Interrupt servicing then can be provided by flowing the interrupt data frame through the PRF ISA of the PE's 20 MBT 40 to de-multiplex the data onto other PEs 20 in the IPCell 700, e.g., in a block 900 interrupt processing pipeline. When validated by COP of the IPOverlay for the input device, the data may flow for applications processing in an appropriate IPOverlay 950, such as from a keyboard device into a time card data entry program, such as 954 in FIG. 2. From the IPOverlay 950 realizing the application, a listener IPCell 700 transfers keyboard data into the time card IPOverlay 950 above IPCell 954 which then moves it into the appropriate place of the screen metaphor in the time card IPOverlay, corresponding to a physical place on the display. The time card IPOverlay application can then initiate the transfer of the keyboard data input characters towards a 900 block associated with the display. Those characters then can be delivered to a specific PE's 20 output frame 52 from which they can be used to form the display by the display device (not shown).

The distribution of OS functions to distributed PRF-ISAs with COP-defined space, time, and bandwidth limits monitored by PE's 20 in each of the clusters of the blocks mentioned above assures that the OS itself is strictly primitive recursive, always obeying COP resource constraints and always synthesizing COP-specified observable behavior. Multiple PEs 20 in a cluster may realize the same behavior, which can be cross-checked by the IPCell 700 before moving results to the IPCell 700 output interface 500. These steps synthesize a provably self aware operating system (PSAOS), as illustrated in FIG. 2.

PRF software development environments with support for PRF programming that, e.g., eliminates the use of WHILE and UNTIL loops and other general recursive function (GRF) constructs in the hardware and software, can optionally allow programmers to write code using WHILE and UNTIL loops. The COP facilitates the automatic translation of prohibited WHILE and UNTIL constructs into Repeat N constructs synthesized by configuring N PE 20 clusters into a pipeline, or by circulating data among PEs 20 in an IPCell 700 for up to N times.

The COP defines N for each authorized process from top-down enterprise rules and other systems engineering considerations available at design time. These constraints on N may be learned via ML during operations, e.g. to optimize resource usage. These constraints on N also may be extended on an exception basis when IPOverlays 950 for global policies (FIG. 1 at 150) allow and when enterprise functions (FIG. 1 at 152) allow and that multifactor biometrics (FIG. 1 at 154) for multiple attesting supervisors and that applications (FIG. 1 at 156) mutually support.

The PRF SAOS can form a distributed interpretation of the COP at the middleware layer (FIG. 1 at 162) via distribution of self-awareness and OS functions through IPCells 700 and IPOverlays 950, to support applications (FIG. 1 at 156) via consistent flow down to resource control 160, interrupts 158, and hardware 82, e.g., PEs 20. This can facilitate data and function processes of conception, initiation, life, extermination, and reclamation, while enhancing rapid design-program-test-support-retire cycles to enhance software productivity.

A suite of sensors 32, shown in FIG. 3, with associated processing, whether stand alone or integrated, enable the system 1000 to continuously monitor the state of the system 1000 (e.g. power supply, thermal environment, physical objects in proximity). The system 1000 can also monitor the state(s) of its networks, e.g., via time domain reflectometry, identification friend or foe (IFF) in radio channels, and via associated RAND/SRES cryptographic exchanges. The system 1000 can also continuously monitor the state of its human users, e.g., via audio, video, proximity, tactile, and thermal, and other multifactor biometrics (FIG. 1 at 154).

The disclosed subject matter can establish and monitor the boundaries of the system 1000 to include the physical facilities, the physical machine rooms, and the people who use, operate, and maintain the system 1000 as part of the system 1000 itself, via the input/output interfaces, e.g, 900 in FIG. 5, realized via specialized IPCells 700 consisting of clusters of PEs 20 with MBTs 40 configured for distributed PRF SAOS and protocol stacks. Controlled permeability, aggressively enforced PRF requirements and data termination, can be utilized with the resulting self-awareness, applications-awareness, and user-awareness needed for enhanced computing and communications security.

The disclosed subject matter can employ the systematic insertion of noise in quantities sufficient to cause the system 1000 to destroy itself via embedded power sources. The embedded power sources can be utilized, e.g., at the chip level 20 to backup external line power that is supposed to be provided to the chip. When the chip loses external line power or when its on-board batteries are not holding sufficient charge, the chip can alert the IPCell 700 of which it is a part by placing an appropriate data thing (alert) in its output frame. The IPCell 700 then may remove data from the chip and power it down. When powered down, the chip employs its on board batteries to continually write its random signals from its signal generator(s) 22 onto its memory 40 to destroy all data in the MBT 40 during its autonomous power-down cycle. Alternatively, the IPCell 700 may reroute power to the chip, e.g. by switching circuits controlled by the IPCell 700 or higher level IPOverlay 950.

Within a short finite time the chip must be powered and attested externally by multiple sources. e.g., via channels 60 that bear cryptographic relationships to each other per the unique random signatures 54, signal generators 22, and correlators 24 and that are knowable only to the authorized originators and to authorized sources of support of the system 1000.

Data exchanges among ISC2 systems 1000 can be accomplished via secure channels such as IPSec with RSA trusted parties for which users have no authority to adjust the security settings defined by the COP. Furthermore, no data is accepted for download by any ISC2 system without a cryptographically verified signature, date, and expiration date, for example via RSA public key exchange, e.g. for music or video purchase. ISC2 systems do not accept data that must be stored in its original form for more than a few seconds (e.g. no cookies or unauthorized downloads). The overlay interfaces 900 converting the data (e.g. music) with its date, signature, and expiration date into internalized form that is error control coded, encrypted via a distributed A(*) process, and striped across multiple MBTs 40 of multiple PEs 20 in multiple IPCells 700 for storage, e.g., in a distributed set of information representation clusters 100.

The IPOverlay 950 must refresh all of the elements of that stored data periodically according to the COP or the data is destroyed by default. In order to retain the data for greater than ½ the time allowed by its license, the COP specifies that a relicensing process must be initiated by the appropriate IPOverlay 950 and validated by the system 1000. If the license is not refreshed within COP specified ¾ of the license time, users are alerted to the plan to destroy the data. The user then is free to intervene to assure licensing, or to allow the license to expire.

Destruction of data by default in the ISC2 PEs 20, IPCells 700, and IPOverlays 950 assures that when set up for a given use for a given period of time, the data will be automatically and autonomously destroyed throughout the ISC2 system 1000 by the default operation of the MBT 40 processes before the license has expired. The disclosed subject matter, thus, assures the digital rights of the creators of data to achieve digital rights management (“DRM”). In addition, the COP of ISC2 systems 1000 is configured by default to not allow any ISC2 system 1000 to forward or share any of its internalized licensed data.

The disclosed subject matter also can assure that data cannot be employed in a manner not authorized by the owners of the data, thus fully defeating identity theft. The ISC2 system 1000 according to aspects of embodiments of the disclosed subject matter may further serve to render insider threats possible only to the degree that all of the people connected with the operation of the system 1000 enter into a conspiracy to defeat the system 1000.

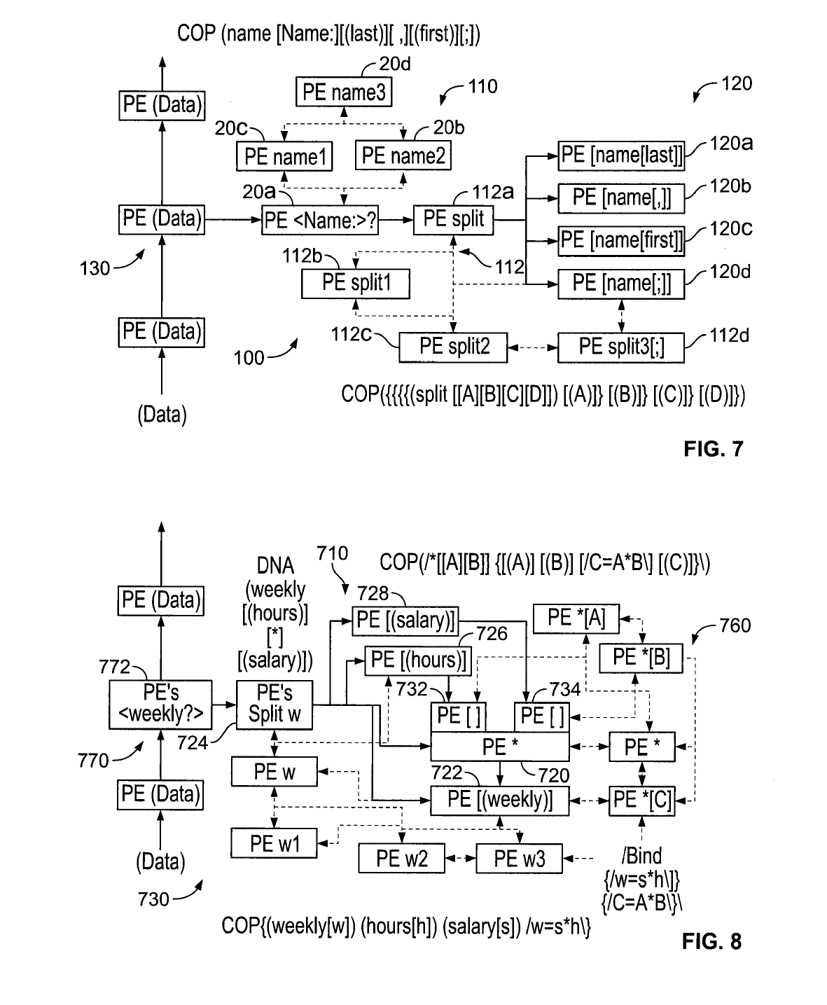

Examples of the operation of the system will now be given, in the context of performing simple operations, in the exemplary case of preparing a weekly paycheck for a fictitious employee “Joe Jones.” As an example, and operation entitled name representation will be explored. The COP system identifiers for “name” can be (name [Name:][(last)][,][(first)][;]). Starting with a flag “Name:” the system identifiers for “name” can include also the thing “(last(Name:))” a place comma standing for itself “,”, the thing “(first(Name:))” and end with the place delimiter semi-colon “;”. This system identifier of the COP can be used to instruct the system 1000 on what a name consists of and of how to assemble it and how to store it, e.g., in the PEs 20, whereby the PEs 20 can save the “Name:” system identifiers, e.g., in multiple clusters, as illustrated, e.g., in FIG. 7.

The system 1000 may provide for parsing names and storing names. A PE cluster 110 of PEs 20a-20d for the system identifiers for the cause: assemble Name, “<Name:>?” can express the system identifiers for “name.” The system 1000, in this case in an information processing cell 700 having a plurality of PEs 20, e.g., arranged in clusters, e.g., 110 and 112, can find data with ‘Name:’ as a first element. The splitting cluster 112 can also act to split a composite thing “(Name)” into component parts, as noted above, i.e., utilizing the system identifier of the COP “({{{{(split [[A][B][C][D]]) [(A)]} [(B)]} [(C)]} [(D)]}.” The (split) and (name) system identifiers map to each other because each has four parts. For the system identifier “(name [Name:][(last)][,][(first)][;])” the system identifier expression mapping associates (split . . . [A]) to (name . . . [(last)]) represented as [A] ⇄ [(last)]. The other three components of each composite (thing) map to each other respectively as: [B] ⇄ [,], [C] ⇄ [(first)], [D] ⇄ [;], which can then permit the system 1000 to split “name” for storage, e.g., into a cluster 120 of four parallel PEs 120a-120d, shown in FIG. 7. This follows a principle for striping regular expressions (“regex”).

With respect to the system 1000 storing information, such as storing “Name,” as an example, the PEs 20 used for storing “Name,” such as the cluster 120 in FIG. 7. consisting of as an example, PEs 120a-d, for [Name[last]], delimiters, and [Name[first]], can store the first and last names in memory locations of the MBT 40 in each respective PE 120. When (name) is split for distributed storage, the IPCell 700 in which the storage occurs allocates its next (thing) index to this particular (name) thing. The (thing) index consists of a (thing) base index assigned by the IPCell 700 when the name object is accepted into the IPCell 700 plus a set of PE 20 indices. The (thing) base index can be a sequential integer assigned by the IPCell 700 as (things) enter. These (thing) base indices can be generated by the IPCell 700 entry interface block 500, distributed to the IPCell 700 interface monitors 600 at both input and output points 500 of the IPCell 700.

This (thing) base index is part of the PE(data) input 130 presented to the PE clusters 20a-d and thus to PE clusters 112a-d and 120a-d. The PEs 120a storing (name([last]) can respond to its storage of the last name (or to any part of it) in its MBT 40 by reporting the (thing) base index and its own assigned index within MBT 40 as a new (thing index) in the form specified by an index template of the COP, e.g. (base, index-last) for that part of the thing. This (thing index) presented at the output frame 52 of the PE 20b is aggregated by the IPCell 700 interface output 500 with the PE 20 identifier (e.g. a pseudo random 8 bit tag based on the PE's 20 relative position in the IPCell 700).

The associated IPCell 700 output interface monitor 600 associates this detailed index with the (thing) base index and an IPOverlay 950 identifier, completing the realization of a unique system-wide (thing) index, (overlay#. cell#. thing. {[PE120a. index] . . . [PE120d. index]). The degree of redundancy of storage of such (things) is determined by the COP. Redundancy may be minimal where only a (thing) identifier is known to the system 1000, or the system 1000 may retain a complete image of the (thing) in overlay interfaces 900, redundantly reflected in overlay interface monitors 800 and/or 700, and/or in IPCell 950 interfaces 500 and monitors 600, or in completely redundant cells or overlays, e.g. for speed optimization. All elements of a given (name) therefore share the same system-wide index and therefore can be retrieved together as a single name, such as from PEs 120a-d.

The parallelism and pipelining of PEs 20 allows for both striping and random distribution, e.g., via a cryptographic key. Languages like Ruby and Java's Object Space include hash maps in which a block of storage is allocated to the storage of data for access by content, such as employee name and address. Hash.name is a location that stores a value, so Hash.name=address associates the employee's address with the employee's name. Similarly, an IPOverlay 950 may allocate an IPCell 700 for distributed storage of the address hash. As is well established with GSM protocol, the A(*) function will yield a signed response SRES for a random challenge RAND. As well established for the TCM, the unique random signature 54 is never disclosed, but rather is employed in A(*) so that random bits may be extracted from a PE by the challenge RAND=0.

The SRES provides a random block of bits (a blit) to the IPOverlay 950 which this IPOverlay 950 associates with the PE's 20 MBT 40 for storage. An IPOverlay 950 then may employ an embedded IPCell 700 as a hash map, randomly striping chunks of (name) and (address) across all of the potentially thousands to millions of PEs 20 in the cell by indexing each PE 20 via its associated blit. The (address) things then are randomly distributed to the hash IPCell 700 and later may be reconstructed via the blit sequence used to split (name) and to store associated (address) things split randomly via a blit. Alternatively the bits of a (name (address)) pair may be stored as (name[first]) in parallel with (name [last]) in the IPCell 700 designated by the IPOverlay 950 for this function, as specified in the COP.

Therefore, from a security perspective, if one PE 20, such as 120c from the cluster 120 in FIG. 7 is removed, only some striped chunk of “[first]” is removed, such as “J” or “o” so, because of the difference between logical and physical proximity of channels 60, in all cases, data migration out of the system via PE 20 removal is minimum and random, even in the case where data is stored unencrypted. Since a given PE 30 may store A(“J”) in its MBT 40 instead of “J”, the PE 20 may encrypt the data. Since A(“J”) does not repeat, the PE 20 cannot be used to recover “J” from A(J). The IPCell 700 may reconstruct “J” from A(“J”) using its own copy of the unique random signature that all PEs 20 of the given system 1000 share.

The other PEs of the cluster 120, such as 120a, 120b and 120d preserve the remaining “name” information data via error control coding, as is well known in the art. A removed PE 20, such as from the cluster 120, i.e., PEs 120a-d can sense via the absence of correlation 60 that other PE(s) 20 with which it was clustered is/are missing and the other PE(s) 20 can sense that the one PE 20 is missing, and the respective PEs 20 can be set up by the COP to destroy the (name) and all other data that each contains.

Another example of system identifiers of the COP used, e.g., within a PE 20 or group/cluster of PEs 20 relates to the operation “multiplication.” The system identifiers for “multiplication” can be “(/*[[A][B]] {[(A)] [(B)] [/C=A*B\] [C]}\),” wherein the input places are [A] and [B], which can then form a path to an output place [C]. The action between the input places [A] and [B] and the output place is C=A*B. This action may be performed in the PECell 20, e.g., by a multiplication “*” MBT 40, e.g., filled into memory. As an example, with [A] [B] being 2 bits each and [C] being four bits, a 16 address location table can be utilized, with each address location having data storage space to accommodate the type of data, e.g., number data, e.g., a digital number of some bit/byte length or a floating point number with selected fixed number of significant digits and an exponent of some selected size, defining each place in the exemplary table of sixteen address locations. Thus, e.g., [00][00]=[0000], i.e., the place zero times the place zero equals to place zero, or, as another example, [10][10]=[0100] (2×2=4), that is, the place 2 times the place 2 equals the place 4, or 3×3 =9, i.e., the place [1001], and so forth.

As another example, the system 1000 may be utilized for a task, such as payroll processing. The system identifiers for as an example, “weekly payroll” can be “([weekly [(hours)] [*] [(salary)]]),” and with “{(weekly[w]) (hours[h])(salary[s])/w=s*h\}” the input places can be [hours[h]] and [salary[s]]. These can be utilized to form the path to the output place [weekly]. In order to utilize the multiplication action /C=A*B\, the system 1000 can use a binding action /Bind {/w=s*h\]} with {/C=A*B\}\, whereby the value (w=s*h) that results can be saved in the place [weekly].

The virtual machine according to aspects of embodiments of the disclosed subject matter can thus utilize its system identifiers to organize data things and processing paths and actions. The processing elements PEs 20 forming IPCells 700, in turn forming IPOverlays 950 and groups of IPOverlays, with related functions and specified hierarchy can be utilized to provide the necessary redundancy, auditing and isolation to form the desired improved secure computing and communications system 1000 according to aspects of embodiments of the disclosed subject matter.

Further to the example of payroll processing the following serves to make linking data more explicit and show the flow from data source(s), the initial operation/manipulation upon and with the data, and linking calculations and manipulations being made, e.g., within IPCells 700, IPOverlays 950 and groupings of IPOverlays 950, and between and among each of these entities. A top down discussion of the improved security computing and communications System (“ISC2”) system 1000 is followed by a discussion of information data flow through the system 1000.

Also described will be malfunctions that can be internally sensed by the system 1000, e.g., to shut down a particular entity(ies), and how such is sensed, and how, if at all, the entity(ies) can be recovered, if and when the system 1000 gets back on track.

At the enterprise level the ISC2 system 1000 can be considered as illustrated in FIG. 1, and in particular with regard to the performance of an exemplary payroll processing application task, such as producing a paycheck for the fictitious employee “Joe Jones.”

This first overview section identifies the particular parts of the system 1000 needed for performing applications, e.g., payroll processing. The application discussed is a simplified use case, processing the weekly payroll for “Joe Jones,” e.g., from information contained in weekly time cards and hourly salary data.

At the highest level of the system 1000, the enterprise level FIG. 1 at 150, can be policies regarding the exchange of data between, e.g., the corporate entity “self” and the rest of the world, which can be regarded as “unknown,” and is expressed in the system identifiers referred to in aggregate as the COP via the unique tag UNK, the unknown. The “system identifiers” can be utilized to express the relevant policies. For example, it may be OK in some ISC2 systems 1000 for a data entry clerk in India to enter time cards, but not unless there are multiple authorities, e.g., M-authority 152 in FIG. 1, that independently verify this procedure.

In order for the ISC2 system 1000 to accept this arrangement, the system identifiers can be utilized to define, e.g., the time card data entry office in India as one of the multiple domains, e.g., M-domain 154 in FIG. 1, of the system 1000. Each data entry clerk can then become known to the system identifiers of the system 1000, e.g., as part of the definition of the system “self.” This may be accomplished in sufficient detail, e.g., using audio and video sensors and other sensors, such as thermal (e.g. face template recognition) sensors over time and via machine learning.

The system identifiers of the COP, e.g., [India] as a place, (time card) and (clerk) as things—people are things in the COP—and /data-entry\ as an action to specify via [India {/data-entry {(clerk (time card) (self)}\}] that such data entry clerks in India can enter time cards to be provided by a {path} to the (self), in the example system, e.g., via the name of the employee (in a commercial application, the employee number might be used or also be used). Therefore, the data entry personnel can be isolated from access to other personal data such as salary.

In the example system, there may be no remote M-domains 154, so the employee data may all originate locally. In an ISC2 system 1000 each person (employees, service personnel, and all others) is known to the system, initially by role and subsequently by the machine learning (ML) (156 of FIG. 1) names, faces, voices, habits (e.g. keystroke patterns), and other unique and repeated patterns of interaction. There is nothing special about the ML techniques, but the multiple attestation of the streams from audio, video, and thermal sources simultaneously is the macro-level implementation of the hardware multiple attestation, e.g. of multiple tamper sensors on the chip (M-tamper 82 in FIG. 1). The middle layers (crypto 158, cell 160, and overlay 162) are discussed in the present application. Without multiple attestation of personnel, the insider threat is not addressed, while without multiple attestation of the COP at all levels from hardware through software, personnel and policies, the system 1000 design would no longer be secure. Therefore the measures of the layers 150 on the top down through 82 at the bottom of the system 1000 illustrated in FIG. 1 are mutually interlocking and supporting via mutual attestation consistent with the COP system identifiers.

The ISC2 system 1000 design, then, is top-to-bottom based on multiple-attestation. Nobody can access an ISC2 system 1000 in any way, including on a tour of the facility, or incidentally, e.g. delivering a sandwich to the office, without the attestation of at least three people that the interaction is legitimate. the attestation can identify the interaction either as an example of one of the behaviors described in the system identifiers of the system 1000 COP or as an exception that all three of these different people with complementary cross-checking roles mutually and simultaneously support.

According to aspects of the disclosed subject matter, secure hardware, the instruction set architecture (ISA), the PRF-SAOS, and the virtual machine (“VM”) disclosed here can operate together to make the basic calculations of the payroll process, such as “weekly earned pay” and “social security deduction.” Turning to FIG. 2 there is shown how information processing overlays 950 (“IPOs” or “IPOverlays”) can work together to realize a payroll system within the enterprise level system 1000.

For the purposes of this example, an example of a payroll system, as illustrated in FIG. 2, can consist of three IPOverlays 950, as illustrated in FIG. 5: one for salary 952, one for time card input 954, and one 956 for combining salary and time card information, e.g., to print a weekly pay check. Although an operator of the system 1000, represented by the photographs 970 in FIG. 2, may specify “payroll processing behaviors,” e.g. by proposing additional system identifiers to the system 1000 or IPOverlay(s) 950, additional human attestation may be required before the system 1000 could implement any such changes, as indicated by the attestation operator, represented by the photograph 972 on the top right of FIG. 2.

Following FIG. 2 from top to bottom, the IPOverlay 956 to print checks may be encapsulated in a single IPOverlay, e.g. box 956, reflecting the input/output interface in which ISC2 1000 encapsulates such collections of functions, as is also illustrated with respect to the IPOverlay 950 of FIG. 5, within the input/output interfaces 900. In addition, as illustrated by way of example in FIG. 2, the internal structure of the Time Cards IPO is illustrated, showing in the IPCell block 970 Cell Awareness and in the subordinate PEs that there may be multiple time card cells (not shown) or multiple PEs 20 supporting a single time card cell as shown at 970.

The Salary IPO 952, similarly can consist only of one salary cell shown at 952, consisting of multiple PEs 20 at 970 or may consist of multiple IPCells 950. As shown at 970, the function of a PE 20 may be primarily that of processing, where the MBT 40 functionality has been loaded to realize the PRF-ISA in table lookup, or the same PE or alternative PEs may be employed with MBT primarily as memory (M) as indicated at 800 and as previously explained for (name[(last)]) in FIG. 7 at 120b. In a commercial application, related functions could be synthesized in other cells within the overlay (such as for time card reporting to supervisors) or possibly grouped into additional IPOs (such as a tax IPO). Wherever functions are flowed down from the human interaction level to machine performance, both system identifiers and machine-machine verification can be involved, e.g., expressing the system identifiers as a model of computing, a comprehensive organization plan, comparing the model to the input and output of the associated computing, and verification that the time spent, memory used, and even the power dissipation are consistent with both the system identifiers and with the patterns of use that the ISC2 system 1000 and/or components of the system 1000 have learned over time, e.g., by observing and ML.

According to aspects of embodiments of the disclosed subject matter, the ISC2 system 1000 COP provides a kind of “systems DNA,” i.e., system identifiers can be used to make the system 1000 self-referentially consistent and self-aware. Such system identifiers can be expressed in a compact and structured form of human language as a pointer, i.e., an index to learned behaviors, e.g., as applied in cognitive linguistics as a formal method of modeling the behavior(s) of the system 1000.

The system identifiers of the system 1000 and its components can be used to establish lists of the things of the system 1000, i.e., “the things-of-S” and to compactly specify rules for how to structure the system 1000, i.e., “how-to-build-S.” Simply speaking the system identifiers can equate to “S[[(things)] how-to-build]”. This can be illustrated as shown in FIG. 6 and in FIG. 7. In FIG. 6 the system identifiers identified in the legend include a system 1000 “S” that includes two things, thing zero 210 (written compactly in parentheses as “(0)” in the system identifier, i.e., “thing0” 210 in FIG. 6, and “thing 1,” 212, similarly compactly written (1) and illustrated in FIG. 6.

As FIG. 6 shows, thing1 210 can move (which is “action1” 214) from place1 216 to place4 222 via a path1 230. This can happen, e.g., if “thing0” 210 does something that is recognized by cause1 240 to cause, i.e., initiate an action “/action1\ 214.” The system identifier can express this as “/1{1[1(1)] [2] . . . }\”, meaning that the system 1000 allows an action /1 . . . \ 214 where a thing (1) 212 that initially is sitting in place1 [1 . . . ] 216 of path1 {1 . . . } 230 can move down that path to place4 [4 . . . ] 222, passing through place2 [2] 218 and place3 [3] 220, if and when caused by cause1 <1> 240.

That action itself is a thing, so the system identifier can show the action in its own level of parenthesis and it also can be listed as a thing in the initial list of things of S, S[ . . . ]. All of the behavior(s) of the system 1000 and its components may be expressed in terms of concrete and abstract things and their four fundamental definers, location, such as initial location termed [place], from among a sequence of places, i.e., a {path} according to an /action\, initiated by a <cause>.

According to aspects of embodiments of the disclosed subject matter cognitive linguistics behavior modeling (CLBM) can model a minimum computationally effective, compact, and self-consistent (e.g. “totally decidable”) machine language, i.e., the system identifiers as discussed above, for describing a system 1000 and its components that can include a computationally intelligent machine (self) to interact with the outside world, e.g., with human beings as operators, e.g., as part of the overall computing/communications entity using only thing, place, path, action and cause to synthesize other constructs. This can provide an optimally compact complete representation language from which all behavioral, ontological, and taxonomic features of the system including the people, organizations, and processes may be constructed computationally or manually.

The overall entity uses the aggregation of system identifiers of its comprehensive organization plan (COP) as a guide to its own structure and function. Each IPOverlay 950 and IPCell 700 refers to its own complete copy of the COP when allocating resources and interacting with other IPCells 700 and IPOverlays 950. Thus, the (self) knows what it is because the COP specifies the (self) in behavioral terms.

The system uses the COP like a person uses their own self-concept to understand itself. The payroll system's COP specifies that it is a payroll system: COP=(self [(payroll (employee (time card) (hours)) (paycheck (weekly pay (taxes)))) . . . ) The text ‘payroll’ has no meaning without the rest of the COP, but even with the list of things, the COP shows the (self) that it is concerned with employees and paychecks because these are the dominant (things) of the (payroll) thing. Based on the /data-entry {(clerk (time card))\ further contents of such a COP, the actions of the system are specified with respect to the fundamental things of the system. The operator(s) and users of the system know what these things mean, and therefore the (self) and (operator) are mutually grounded via the system 1000 system identifiers as a starting point, augmented by machine observation of operators utilizing the system to perform tasks. With this PRF machine language, as expressed in the system identifiers, a virtual machine (VM) is exhibited that can be used to organize the performance of the tasks of and interactions with the outside world in a way that is easy for users, managers, computer scientists and programmers to mutually understand. A cognitive linguistics VM (CLVM or simply VM) based on things, places, paths, actions, and causes thus can embody a standard way of communicating the operation of a massively parallel processing hardware architecture as a part of the overall ISC2 system 1000.

Underneath the VM layer can be a collection of hardware processing elements that implement the VM, e.g., in a parallel pipelined architecture, e.g., through selection of and translation of the appropriate parts of the system identifiers into collections of PEs 20, clusters of PEs 20 cooperating for multiply attested representation 100, COP 200, processing 300, cryptography 400, interfaces, 500, and interface monitoring 600 for the larger IPcells 700, and IPOverlays 950 and groupings of IPOverlays 950 comprising a complete system 1000.

This can occur in a very unconventional way. Most VMs are simple abstractions of a vonNeuman register machine, where instructions and data are drawn from memory, processed in registers, and returned to memory. The Java Virtual Machine (JVM) is a common example of such VMs. The commercial product VMware has contributed to the popularity of VMs for the early Intel architectures as well as for the use of VM-based hypervisors for greater security.

However, the conventional VMs are self-referentially inconsistent because the underlying hardware, e.g. the Intel ISA, can compute using general recursive functions, and this makes it impossible for any VM to be secure, based on Cantor's famous diagonalization proof which establishes the undecidability of conventional safety and dynamic security systems including hypervisors. The currently disclosed architecture, however, is not a register machine, a VM, or hypervisor. Instead, according to aspects of embodiments of the disclosed subject matter, the dimensions of system identifiers, e.g., the five dimensions of the system identifiers (thing, place, path, action, cause) can be mechanized so that all computing, communications, and human interaction with the system 1000 can be expressed in the system identifiers, i.e., using the five dimensions for creating the non-Turing, non-vonNeuman VM.

The ISC2 VM thus defines things, places, paths, actions, and causes as VM elements. Things include data: integer and string or other data types, since data are the basic things of information processing and communications. Places are the registers and stacks that hold the data in the VM. Paths are flows and operations (programs) that process the data in the VM. Such paths occur in vonNeuman computing, but are not modeled in the conventional ISA nor in the conventional VM, leading to self referential inconsistency. Actions occur when the ISC2 VM is used, constraining the actions of the VM. Although actions occur in conventional ISA and VM, they are not consistently modeled in the ISA or VM itself, so the system does not know that it is a computer, does not know what it is supposed to be doing, and thus will do any action that is loaded into its registers, safe or unsafe.

Causes initiate and control the VM via behavioral metaphor, not logic. For example, logic requires each assertion to be either true or false. The assertion: “This sentence is false” is neither true nor false, it is a paradox. If it is true, then it is false and vice versa. The COP includes a category “inconsistent,” INC. When reasoning via metaphor, the system 1000 performs actions such as setting and testing the truth-value of an assertion to see what happens.

For “This sentence is false” the act of assigning its truth value to true initiates a cascade of action to invert its own truth value from true to false. Upon observing this result, e.g. in an IPCell assigned to evaluate the assertion, the (self) detects the true/false/true/false looping, which is an example of exceeding space-time-power resources. The (self) places the associated IPCell 950 into it's INC domain, a relatively mild form of quarantine, alerting three human beings known to the system that the assertion “this sentence is false” violates the space-time-power constraints of Boolean truth values by creating a self-referentially inconsistent loop. No modern computer incorporates the detection and quarantine of such infinite loops into the ISA, but this is the essence of ISC2's PRF ISA. Indeed, all contemporary commercial operating systems require such infinite loops, e.g. in the OS kernel. The ISC2 OS is distributed across a host of processors, PEs 20, IPCells 700 and so forth, but when not presented with specific data on which to perform specific action may power down all of the PEs 20 not in use. Only a few research chip sets can accomplish this feat of partial power down. The ISC2 PRF-SAOS leverages the hardware for increased security.

There are many possible ISC2 system identifiers and VMs. According to aspects of embodiments of the disclosed subject matter, an ISC2 system 1000 can be optimized in the sense of requiring a minimum effectively computable set of things, places, paths, actions, and causes. For ease of reference, the following can be “things” in the system identifiers of an ISC2 system 1000 and associated VM: (Self) (Unknown—UNK) (Domain) (Data Block) (Signature) (Processor) (Processing Element—PE) (Memory Element—ME) (Interconnect—IX) (Sensor) (Sensing Element) (Correlator—XE) (Signal Generator—XG) (Effector) (Effector Element—EE) (Power Source—PS) (Mule—PE Group) (Termination PE Group) (Binary Digit) (Binary*N) (Octal Digit) (Hexadecimal Digit) (Sign) (Integer Digit) (Exponent (Base) (Floating Point Number) (Rational Number) (Uncertain) (Infinity) (Undefined) (Nil) (Safe) (Verifiable) (Not Verifiable) (Ambiguous) (EQUAL) (UNEQUAL) (Zero) (TRUE) (FALSE) (Binary Logic) (Character) (String) (Expression) (Bag) (Set) (Sequence) (Randomized (thing)) (method (seed)) (Random) (Fault) (Attempt) (Recovery) and (New).

All of the places, paths, actions, and causes that follow also are things since anything that one may express or refer to in language whether abstract or concrete or some combination (such as the color red) itself is a thing in this self-referentially consistent architecture. As such, the present subject matter comprises a self-referentially consistent interlocking set of designs for hardware, firmware, software, applications, people, and policies.

The VM's places can be considered as opportunities for new things to take on the character of the things listed above. For example, the (self) thing may contain all of the things known to the (self) in the associated place (self [ . . . ]). There also can be known unknowns in the self, such as the time of the next earth quake, expressed in the CLVM as (self [ . . . (UNK[(earthquake[(time[(next[(UNK)])])])])]). In a database, there may be ad hoc and product-dependent flags, tags, or constants, or other representations, e.g., that represent the fact that a value is or is not in the database such as UNK. There can be specific items that stand for themselves, such as the thing (UNK) that may be a unique unknown thing as well as the class of all things that are unknown or specific unknown things such as the lack of data in a database. Thus, the semantics of (name[last Joe] [first (UNK)]) is evident to anyone: user, programmer, systems administrator, or manager.

In applications expressed in the CLVM and system identifiers, one may employ named places as follows: [named-place contents]. Places occur in the system identifiers of the COP, e.g., for a payroll application. For example, the system identifiers expression ([weekly [(hours)] [*] [(salary)]]) contains three parametric places, named [weekly . . . ], [(hours)].and [(salary)]. There also is a functional place, [*], which expresses the fact that a multiplicative function is occupying some place such that it can compute the product of the parameters to its left and right, i.e., in the payroll example given, hours and salary. The place [weekly] can enclose the product because the place [weekly] is the location into which the product is delivered. That is, e.g., when the product object comes to exist, then it becomes the “thing” (weekly), having been computed as (hours)*(salary). So these VM places can be established by mention in the system identifiers and may be distributed throughout the collections of, e.g., processing elements 20 in the IPCell 700 and IPOverlays 950 and groupings of IPOverlays 950.

The system identifiers for an example of a payroll application can include a subroutine that can compute the weekly salary for an employee. This software sub-routine may be modeled in the CLBM as the following path:
{(weekly[w])(hours[h])(salary[s])/w=s*h\}
   The input places are [hours[h]] and [salary[s]]. These form a path to the output place [weekly]. The structure of the application invokes the multiplication action /C=A*B\. The binding process between the application specification and the function to multiply numbers may be expressed in the VM action /bind\ as:
/Bind {/w=s*h\]} {/C=A*B\}\
   The binding functions may be performed, e.g., by script interpreters like Ruby in conventional computers. In the ISC2 1000, the binding is a (thing) as it is in Ruby, but unlike Ruby, the ISC2 (binding) can create a pipeline, e.g., among clusters 100, 300 of self-checking processing elements 20. As an example when hours are entered into the system for an employee whose salary already is in the system, then the weekly pay can be computed as a processing path where a table lookup occurs in the memory based transform 40 of a PE 20 to create the product. The value is a thing, (w=s*h), that tags the results to be retained in the place [weekly]. The VM thus is guided by the system identifiers to organize data, i.e., things and /processing actions\ along {function paths} specified by the system identifiers of the COP. Information Processing Cells 700, IPOverlays 950, and groupings of IPOverlays 950 can gather related functions hierarchically for redundancy, audit, and isolation of faults.

The following are the actions that can be performed by the VM. The /scope (thing) (domain [[(a)] . . . [(b)]])\ action can be used to place a (thing) in the given domain, allowing it to occupy the places listed or the range indicated by the limits and the ellipsis ( . . . ). Defining domains can be important for improved security. PEs 20 in clusters monitor the domains of inputs and outputs 50, 52 for functional PEs 20 with the capability to curtail PE 20 function that violates a-priori domain expectations.

The action to /link {path-name [(Reference-thing)] [(Associated-thing)]}\ creates a path between a reference thing and some associated thing. Thus in a payroll application, a (name) may be the reference thing to which might be associated a new thing such as (Dr.) if the title were not originally part of the definition of (Name), which might have contained only the first and last name as places: (Name[First][Last]). The /link (Reference-thing) (Reference-thing [New-place])\ creates a new [place] on (Reference thing). The link operation defines a path between the (Dr.) thing from some information representation block 100 to some other block 100, in this case within the (name) IPCell 700, provided that the action is consistent with the COP.

Instructions for the VM may be organized into blocks via the /block\ action, such as /block Block-name {[/first instruction\] . . . [/END\]} (resources(space) (time) (bandwidth))\. This action creates a {path} called a block with an optional block-name (all names are optional since all things are self-referentially consistently indexed and thus may be referred to either by name, by value, or by location). The resulting block is series of instructions located in a sequence of places terminated by the thing (END) which stands for itself and for its ability to terminate execution, which is the /END\ action.

With such a block can be associated resources for space, time, and bandwidth. When such blocks are allocated to clusters of PEs 20, some of the PEs 20 can perform the operations, while other PEs 20 can check for input and output domain consistency, for use of space inside the PE 20 MBTs 40 inside of an information representation block 100, as shown in FIG. 4, e.g., for clock speed of the PE 20 (which defines bandwidth), and for time delay through, e.g., through the MBTs 40 in the PEs 20 of information transformation blocks 300, per the COP. If any of these constraints are exceeded, alert, alarm, and recovery processing can be initiated as defined in the COP. Space in ISC2 1000 is proportional to the numbers of functional PEs 20 that retain data, e.g., in the MBT 40 of the PE 20, (in addition to the 3× additional PEs 20 that attest to and monitor the functional PEs 20). The COP defines and the IPOverlays 950 and IPCells 750 verify the space available, used, and unused, as an example, in every MBT 40 of the PEs 20 in the system 1000.

Time can be measured by a local clock[s] in the signal generators (SG) things 22, 24 in each PE 20. The parts of the PE 20 used to actually measure time from the local clock(s) are the signal generator 22 and cross correlator 24. The PE 20 can accept data, e.g., in the form of a data communications protocol, e.g., including data frames and control frames. The signal generator 22 creates the PE 20 clock in response to a pattern of bits (start) that can occur simultaneously across the full input interface 50, output interface 52, and correlators 60, C1 . . . Cn.

The (start) bit pattern thus can use n+2 PEs 20, one each for each communications path C1 . . . Cn and one for the input interface 50 and one for the output interface 53, each presenting the applicable subset of (start) to the target PE 20 in order for the PE 20 to power up. When powering up, the elements of (start) presented at a subset of the input interface 50 and output interface 52 and communications paths 60 can constitute the control bits by which the PE 20 sets its clock rate, establishes time in the number of clock ticks to operate before powering down, again automatically.

The PE 20 may also compute its starting offset on its long pseudo-random code determined by its unique random signature 54 (shared by all other PEs 20 in the (self), and can configure its own PE 20 identifier for the birth-life-termination session between (start) and the next power-down sequence for the PE 20. The (start) patterns may not be unique. The clocks of adjacent PEs 20 connected via ports 60 remain in synch via the correlator 60 of each PE 20 during operation. Timing circuits of the PE 20 can increase or decrease the master clock with respect to its internal clock source in order to maintain the correlation of all signals. Well known bit stream correlators, e.g. for CDMA communications systems typically employ three channels for synchronization: early, central, and late channels. The correlator 60 maintains such channels for C1 . . . Cn channels and their combinations, providing error feedback to the PE 20 clock offset circuits to tend to drive the differences of transition times towards zero, thus maintaining clock synchronization.

Bandwidth can refer to the product of the data clocking speed and the number of bits processed, e.g., at the input interface 50 per data clock. Not all data operations need occur at the maximum speed of the PE 20 hardware nor of communications path(s), so the PE (start) control bits may establish a relationship between the internal clock used in the cross correlator 24 and the data clock used to examine input interfaces 50 and to generate and change output interfaces 52.

The (bandwidth) constraint of the /block\ action can define a resource that allows the system designators of the COP to establish for individual PEs 20, for clusters of PEs 20, for IPCells 700 or for IPOverlays 950 a value or range of values of the computing or communications clocks associated with the action(s) of any block defined via a /block\ action of the PRF-SAOS that is managing the associated PEs 20.

The /block\ action resource constraints may be expressed as such in the system identifiers of the COP of system 1000 and the /block\ action need not be performed unless some application needs the /block\ action to be expressed and performed, e.g., in an IPCell 700, e.g., to perform information processing. Once expressed, the /block\ actions can remain mapped into PEs 20 where a path {/block\} is constructed of multiple PEs 20 in multiple PE 20 clusters as in FIG. 7 or 8 until no longer needed. At such time they can self-terminate or can be attacked and destroyed by the termination PEs 20 that, e.g., monitor the functional PEs 20. e.g., via channels C1 . . . Cn and via IPCell 700 level processes monitored via internal process validation, such as in functional blocks 200, 400, and COP as indicated in FIG. 4 by way of example. In addition, all termination PEs 20 can monitor other termination PEs 20 so that anomalies of the monitor resources may be detected and corrected.

Other actions of the VM can synthesize functionality familiar to computer programmers including, e.g., a /choice\ block, e.g.: “/choose choice-block-name <choice> {<choice==condition1> {block1}} {<choice==condition2> {block2}} {<(else)> {blockn+1}} (Rx(Sx)(Tx)(Bw))\” and an /iteration\ block, e.g.: “literate Iteration-block-name <N> {<(N==0)>{Block-0}} {<(Nmaxiterations>N>0)> {Block-Normal}} {<(ELSE)>{Block-Else}}(Rx(Sx)(Tx)(Bw))\” where (Rx(Sx)(Tx)(Bw)) abbreviate resources of space, time, and bandwidth.

Subroutine operations can be mechanized in the VM, e.g., by /call\ operations. In the action /call-return Call-point-name {[/Delegated-action [parameters(values))] [Return(Call-point-name [parameters(values)])]\]} (Rx(Sx)(Tx)(Bw))\, the called operation is mapped into a cluster of PEs 20 of an IPCell 700, e.g., that is supporting the operation as defined in the COP and realized via the VM operation of an appropriate IPOverlay 950. In the pipelined processing of the ISC2 system 1000 architecture, there is no conventional instruction sequence, so, e.g., a /call\ action can place a complete copy or an appropriate subset of a function into an IPCell's 700 pipelined information flow by expressing that part of the function identified by the system identifiers from the COP.

The /call-return\ action may result in the instantiation of a complete copy of the {/Delegated-action\} path as a flow into the higher level pipeline calling for the action (e.g. optimizing for speed) or the /call-return\ action at the IPCell 700 level may route data to a single copy of the /Delegated-action\ within the IPCell 700, e.g., routing results back into the pipeline flow of the application. The larger information processing flow (IPCell 700 or IPOverlay 950) can be used via /block\, /case\, /call-return\ and other such actions to manage the expression of system identifiers in constituent IPCells 700.

For the management of monitoring functions, including of the termination PEs 20, the actions for one PE 20 to /question\ another, to /scramble\ a PE's 20 MBT 40, to /quarrantine\ a PE 20, or to /attack\ and if necessary to /kill\ a PE 20 or an IPCell 700 also can be are managed by the IPOverlays 950. Multiple attestation and error resilient coding in the IPCells 700 of the parts of the system identifiers that are expressed, e.g., in the IPCells 700 can be utilized.

According to its system identifiers the VM of the system 1000 may perform a “Try-Catch-End” action in order to determine whether a (/Block2try\) action will succeed or fail. Such /actions\ may be utilized for synchronization, consistency checking, device readiness checking, and any other /action\ that may result in the appearance of an (error) in any output interface 52 of any PE 20. The VM of the system 1000 operating at the IPOverlay 950 level may block attempts of Block2try acting at the IPCell 700 level, catching faults. The form of the /try-catch\ action that accomplishes this error resiliency can be, e.g., (% are comments):

/try Try-block-name {<Fault> = (Fault {Block2try /instruction1\ /END\}) (Rx(Sx)(Tx)(Bw))}
/Choose <Fault>
{<Fault == (END)> {/Catch\ ... /END\ (Rx(1)(1)(1))}}
{<Fault == (NV)> {NVBlock (Rx(Sx)(Tx)(Bw))}} %NV = block2try results are not valid
{<Fault == (V)> {VBlock (V) (Rx(Sx)(Tx)(Bw))}} % V = block2try returned valid results
{<Fault == (Infinite) > {VBlock (Infinite) (Rx(Sx)(Tx)(Bw))}} % result is infinite (INF)
{<Fault == (Number) > {VBlock (Number) (Rx(Sx)(Tx)(Bw))}} % result is a valid number
{<Fault == (String) > {VBlock(String) (Rx(Sx)(Tx)(Bw))}} %result is a valid string
{<ELSE > {VBlock(String) (Rx(Sx)(Tx)(Bw))}} %result is none of the above
END\ (Resources(Space) (Time) (Bandwidth))\

Since division may result in a division-by-zero error, the action /z=x/y\ may be formed by a /block\ action into a named block, say, DivXY. The action /try DivXY\ could include an appropriate action for the condition <Fault==(INF)> where, e.g., 23.5/0.0 yields the infinite result. The {VBlock} for (INF) handles this exception, e.g. by determining that the /try-catch\ action should return the (Nil) thing, e.g. {<Fault==(INF)>(nil)} to indicate that the /try-catch\ action should return the system object (nil) of the COP in response to this condition. When (nil) is appended to other results in a (string) or (array) of results, nothing is added, so this /catch\ action can be useful in performing actions on non-zero arguments only. The semantics of /try-catch\ therefore are consistent with those of conventional programming languages such as Matlab, C++ and Ruby.

Information processing cells 700, as shown in FIG. 5, can implement applications according to the system identifiers of the COP using, such as, the system identifiers for an employee's name as noted above: (name [Name:][(last)][,][(first)][;]). The data in this case, a name like “Joe Jones” can be presented to the input/output interface 500 (FIG. 4) as a cognitive linguistics behavior model (CLBM) thing such as (Name: Joe Jones). At this level of abstraction of the processing flow, the left and right parenthesis around the thing “name” are like quotes around the strings of conventional languages, but the thing form ( . . . ) indicates to the IPCell 750 that the data has the role of a (thing). A thing can move around and be used in arguments, but cannot perform /actions\, for example.

This strict separation of roles among thing, place, path, action, and cause provides greater security than conventional separation of data from instructions or conventional separation of processes into sand boxes via hypervisors of conventional virtual machines. Every (thing) is distinct from all other (things). Every [place] is created with respect to a specific unique host (thing), thus acting as a very fine grain sand box. Every {path} is created as a unique sequence of specific things, acting as a structured sand box. Every /action\ defines a specific thing moving down a specific path, thus constricting all hardware, firmware, and software functions to obey very tight a-priori constraints for data flow and resource usage. Such may be checked by attestation PEs 20, clusters of PEs 20, IPCells 700, and IPOverlays 950 assigned to monitor the /actions\ of the (self) at all of its levels of abstractions of the system 1000.

To summarize, the (thing), as such, may be stored and used in arguments of functions but cannot be executed. A (thing) form is not a place to put data. Only [place] forms allow that. A (thing) also cannot be part of a VM instruction sequence. Only {path} forms can do that. A (thing) cannot be treated as an instruction. Only an /action\ can do that. A (thing) may interact with a <cause> to initiate or constrain an /action\, but cannot accomplish that alone.

This is in contrast to, as an example, the Intel IA32 processor ISA where a fixed set of n bits, e.g., 32 bits, in a register at some moment in time, can, according to the instruction currently being executed by the operating system and/or application currently running on the processor, assume the role of data, instruction, conditional instruction, address, indirect address, local constant, etc., i.e., any and every role allowed by the operating system. This almost infinite degree of freedom for the role of a piece of information represented, e.g., by the data bits currently contained in a given register, has allowed programmers to implement very sophisticated applications with only a few hundred words of instructions and a few thousand words of data memory, driven by the historical need to so conserve resources, due to the historical cost of memory and processing time. Today, however, storage and processing capacity are basically free, but security is not. Therefore, according to aspects of embodiments of the disclosed subject matter, processing capacity and memory of an ISC2 system 1000 can be better allocated to an architecture that employs internally consistent self-monitoring via the distribution of system identifiers, e.g., in the IPCells 700, e.g., as shown in FIG. 5.

With regard to IPCell 700 processing, an IPCell 700 as shown in FIG. 4 realizes its constituent functions such as information representation 100 via a cluster of PEs 20, e.g., as shown in FIG. 7, wherein data flows 130, such as shown in FIG. 7, can be organized by the IPCell 700 (FIG. 4) as a part of the IPCell 700 input interface 500, on the left side of FIG. 4, and wherein other PEs 20 of FIG. 7 perform the information representation of functional block 100 of the overarching IPCell 700 of FIG. 4.

IPCell 700 has clocks of all of its constituent PEs, one of which, such as PE(data) 130 of FIG. 7 forms a part of the IPCell 700 input interface 500 and may be identified by the IPCell 700 of which it is a part. Such a (cell clock) thing can reflect and control, e.g., via synchronization channels C1 . . . Cn of such PEs 20, the clock(s) of the underlying PEs 20. The PEs 20a-20d, 112a-c, and 120a-d of FIG. 7 can comprise an information representation functional block 100 of an IPCell 700, so that the thing (Name: Joe Jones) can be tagged as arriving to the IPCell 700, e.g., to the input interface 500 by PE(Data) 130 of FIG. 7 at a time that the IPCell 700 delegated to PE(Data) 130 measures and tags to the thing (Name: Joe Jones) entering the IPCell 700 of which the PEs 20 of FIG. 7 are constituent components.

From the input/output interface 500, the data can then be distributed into the IPCell 700. e.g., to distributed memory 120, e.g., in an Information Representation (IR) cluster of the functional block 100. The information representation (IR) cluster may be a cluster of PEs 20 as illustrated in FIG. 7. An IR cluster in the information representation functional block 100 can consist of a large number of PEs 20, e.g., dozens at least, but even hundreds to thousands of PEs 20 in typical commercial applications.

The input interface 500 to the IPCell 700 can push the thing (Name: Joe Jones) into the IR cluster(s) of the functional block 100 and distribute the thing (name), e.g., into a parallel pipeline within the IR functional block 100 as illustrated in FIG. 7. In a larger IPOverlay 950 (Name) could be the contents of part of a larger data structure, a (thing) with associated [places], such as (Employee [Name][Employee#][Start Date] [Salary], etc.), wherein the form of the data is expressed in the (Employee) thing while the specific contents move through the system via (Name: Joe Jones) kinds of things, distributed by the IPOverlay 950 to multiple IPCells 700, e.g., for storage and processing.

In this example, the employee's (name) thing may be used as a tag for associated data processing, so the (name) and (salary) things could be stored together, e.g., in a given IPCell. The (name) and (salary) could be associated via a VM named path template from the system identifiers, such as {/hire (name[ ])(salary[ ])\}, an action that causes the named individual to receive a (salary) with a value ($10) via an action that is performed for each employee, e.g. /hire (name[(Joe Doe)])(salary[($20)])\. Consistent with CLBM, /actions\ tend to be verb forms, while (things) tend to be noun forms to assure that managers, users, programmers, and the system 1000 COP and its instantiations in PEs 20 via the PRF-SAOS VM are mutually grounded: words employed by each. All share the same semantics in the real world.

Inside of an IPCell 700, the thing (name) can flow into the PE 20 clusters of the functional block 100 where it can be associated according to the system identifiers of the IPCell 700, such as by identifying a segment (name [Name:][(last)][,][(first)][;]). So for employee Joe Jones, there is a data thing (Name: Jones, Joe;) that expresses Joe's first and last names. This (thing) also can be called an object, informally, to align loosely to contemporary software usage. In the IPCell 700 of FIG. 4, the system identifiers can point to the input and output IR functional blocks 100 and to the intermediate information transform (“IT”) functional blocks 300, with their clusters of PEs 20 to express the (name) system identifiers which distribute the functionality down to clusters of PEs 20, e.g. of the types illustrated in FIGS. 7 and 8.

Regarding an IPCell 700 information processing via information transformation, the IT functional block 300 of the illustrated example of an IPCell 700 can perform (name)-associated processing, such as computing weekly pay. The applicable system identifiers for weekly pay can be identified by the IPOverlay 950, of which the IPCell 700 is a part, so the system identifiers can define the transformation occurring in the IT functional block 300, including clusters of PEs 20, e.g., expressing the system identifiers as a segment for computing weekly pay: {(name (hours[h hrs/week]) (salary[s $/week])) /w=s*h\ (weekly[w])} as further illustrated through the actions of the constituent PEs 20 of IT functional block 300, as shown partly in FIG. 8.

Thus, the system identifiers of the COP, e.g. as in FIGS. 7 and 8 can express a {path} to get from (name) data to the (weekly) salary [w]. Reading from left to right, the system identifier {(name (hours[h hrs/week]) (salary[s $/week]))/w=s*h\ (weekly[w])} indicates that associated with a (name), inside the parenthesis of the (name . . . ) thing, are the (hours) worked this week, which are stored in the place [h] with units hrs/week, of the (hours) thing of the (name) thing. These hours are multiplied by the (name (salary[s])) in units of $/hour, according to the action /w=s*h\, where w equals the value of hours (h) times the value of hourly salary (s) to yield the value of weekly gross pay (w) to be placed in the location [w]. Thus, the PRF-SAOS VM differentiates the value thing (w) from the place [w] in which to put that value. The IT functional block 300 can perform this action whenever all of the data is available, so it would not be computed until the weekly hours thing (name (hours[h(h)])) is present in the input interface 500 of the IPCell 700 for the named employee for a given week.

Supposing (Jones, Joe) worked 40 hours at $1 per hour. At some point previously, an information representation thing flowed through to establish Joe Jones' salary, such as because of the action /hire (Name: Jones, Joe (salary($1.00)))\. Thereafter, the input information representation (IR) functional block 100 of this IPCell 700 can retain Joe Jones' salary. Subsequently, some other object flowed through to express the hours worked this week for Joe Jones, such as (Name: Jones, Joe (time card (hours(40 hr)) (date (Mar. 31, 2011))). At this point, the conditions necessary for the action /w=s*h\ have been met, so the IPCell 700 can then autonomously compute w=s*h from the data currently in places [s] and [h] of the (thing) called Jones, Joe.

Units of measure can be carried along with the data, so while the multiplication cluster is computing 1*40=40, an associated monitor cluster(s) can be checking that the units of the (Joe Jones) things flowing through conform to the units required by the system identifiers of the COP. This cross-checking constitutes multi-factor attestation of the incoming data because each IPCell 700 contains its own unmodifiable copy of the COP to which the IPCell 700 refers in distributing processing and monitoring functions to its constituent PEs 20. If the units do not agree, then fault handling can suppress any further action and at the IPOverlay 950 level, forensics can be initiated to autonomously analyze the audit trail to discover and if possible to autonomously resolve the issue, or if not, to raise the fault to multiple simultaneous intervention and/or attestation functional blocks, including for human intervention attestation.

IPCell 700 output processing and retrieval can be performed, as an example, once in a period of time, e.g., once weekly, gross salary can be computed, caused by a <time> condition, for example. The gross salary can be expressed in the Joe Jones thing of the IPCell's 700 IR functional block output interface 500 to the right in FIG. 4, e.g. as (Name: Jones, Joe (paycheck (weekly($40)) (date (Mar. 31, 2011))). The central IT functional block 300 can deliver its primary results to the IR functional block 100 output interface for storage, e.g., within the IPCell 700 or another IPCell 700. e.g., by delivering the same results to the IPCell 700 output interface functional block 500. Once located in the output of the IR functional block 100 of the IPCell 700, the employee's weekly salary can be encapsulated as part of the Joe Jones (thing).

The back flow from the IPCell 700 to update Joe Jones' amount paid in the Joe Jones IR 100 could be accomplished by unidirectional back flow through the IPOverlay 950, e.g. as illustrated in the flows of FIG. 5, wherein IPCell 700 may produce salary to be paid in the left most IPCell 700, which salary may undergo additional processing in a subsequent IPCell 700, e.g. in the information processing functional block in the center of FIG. 5, and that may result in a flow of updated information, such as salary paid, back into the Joe Jones IPCell 700, indicated as IPC as the rightmost of the three IPCs in the central part of FIG. 5.

In other words, forward flows and transformations may result in what appears to a programmer to be feedback of salary paid back to the Joe Jones IR functional block 100 of an IPCell 700, but which within the system 1000 via the PRF-SOAS VM is realized as a discrete {path} sequence of limited steps that terminate when the Joe Jones IR functional block 100 is updated. This flow can achieve information processing functionality akin to storage and retrieval of data from a database, but without storing any data on any external media. Also, striping data across constituent PEs 20 can perform storage, such as in FIG. 7, and processing, such as in FIG. 8.

In the IR functional block 100 output 500 of the IPCell 700 of FIG. 4, the Joe Jones name (thing) is made available for authorized retrieval and use elsewhere. Retrieval processing can begin when an interface cohort functional block 600 for output interface block 500, comprised of PEs 20, directs a query object to this particular IPCell 700. The query object can conform to the system identifier-generated template, e.g. (name(weekly[?])).

The result obtained from PEs 120 of FIG. 7 and other similar PEs not shown can be provided to the output interface 500 of the IPCell 700, on the right side of FIG. 4. Specifically, the query object (Jones, Joe (weekly[?])) flowing to input/output interface functional block (500) to the right side of this IPCell 700 could result in the retrieval. The IPCell's 700 self-protection mechanisms 200, 400, and 600 in the figure validate different aspects of the query object. The interface cohorts 600 validate the information in the query. In this example, noise cancellation has been configured for /check-printing\, e.g. by installing a 2000 bit pseudo-random code through the input interface functional block 500 into the noise cancellation functional blocks 200 and into the atrophy cancellation functional blocks 400.

The weekly pay query object can be encapsulated in an authorization object such as (Check-printing [(2000 bit certification)](Jones, Joe (weekly[?]))(date (Mar. 31, 2011))). The 2000 bit code presented can be generated partly by the unique signature 54, such as is shared by all of the PEs 20 in the system 1000 via a key generation function, partly by the (check-printing) entity 956 in FIG. 2, as its unique signature, and partly by the secure hashing of the date-time of the query when the 2000 bit signature is prepared.

This code can be in effect for a finite time, e.g., for N clock cycles, where N can be a relatively small number, sufficient for the query to flow from the (check-printing) IPOverlay 956 of FIG. 2 to the (weekly-pay) IPCell 700 of the associated IPOverlay 956 and back. Some of the signature bits can be cryptographically modified per the system identifiers of the weekly pay computation IPCell 720 of FIG. 8 to certify to the check-printing cell IPOverlay 956 that the amount has been generated by the appropriate part of the (Self).

Since the (check-printing) IPOverlay 956 and the (weekly-pay) IPCell 720 share the same system identifiers, each can confirm that the signature(s) and counter-signature(s) are in accordance with the system identifiers.

If any of this fails, then the noise cancellation functional blocks 200 and/or the atrophy cancellation functional blocks 400 can insert predictable digital noise into the Joe Jones query, quarantine the query, and flow alerts to at least three different people in authority over this process, e.g. 970, 972 and another authoritative person not shown. If these people do not resolve that issue in a time specified in the system identifiers, then the atrophy cancellation functional blocks 400 begin to attack the IPCell 700, destroying its data and functionality, and ultimately destroying the COP itself as one of the last steps in IPCell 700 destruction.

Information representation functional blocks 100 in an IPCell 700, as illustrated in more detail in FIGS. 7 and 8, at a level of abstraction below the IPCell 700 IR functional block 100 can range in level of abstraction from the system level 1000 to the level of PEs 20, can be a collection(s) of clusters of PEs 20 that can, e.g., share the workload of the IPCell 700 by assignment of PEs 20 by an IPOverlay 950 to an IPCell 7000. FIG. 7 shows a portion of an information representation functional block, such as 100 in FIG. 4 that includes formatting representation clusters 20a-d and 112a-c and a storage cluster 120. To the left in FIG. 7 are illustrated a series of PE(Data) PEs 130 in the IPCell 700 input/output interface 500 that can be used, e.g., to maintain a continuous flow of data potentially needed by the IPCell 700 through the IPCell's950 input interface 500, shown in FIG. 4.

Nothing in this input interface functional block 500 data flow can enter the IPCell 700 unless it matches exactly some fixed pattern expressed in the system identifiers for the IPCell 700 and instantiated in the <cause> PE 20a that examines PE(Data) output content via its own input to find the thing (Name:) which has a causal role as <Name:> in this PE 20a. Any data that does not match cause <Name:> may flow into and out of the input 500, as represented by the vertical distribution of the PE(Data) clusters 130 of PEs 20, containing PE (data), but it causes no response whatever in PE 20a. Therefore, as an example of a scrutiny feature of the architecture of the disclosed subject matter, the ISC2 system 1000 is immune to “denial of service” attacks that operate by flooding the system 1000 with meaningless tasks to perform, or attempt to initiate infinite DO loops or the like.

Because of previous elaboration of system identifiers, part of the system's COP for names has been realized in the upper PE 20 cluster 110, including, e.g., PEs 20a-20d. These four PEs 20a-20d can collaborate, e.g., to cross-check each other. The function of these four PEs 20a-20d is to find the pattern “Name:” in the input interface 500 stream of PE(DATA) inputs 130 and to extract from that stream of PE(Data) inputs 130 a valid (name) object.

Like the query discussed above, each (name) object may have been designated by a signature of the originator of the (name) object, in the multi-attestation style that can be defined by the system 1000. the system 1000 may use the system identifiers aggregated into the COP, such as cryptographic or pseudorandom bits specific to the originator of the data, and cryptographic or pseudorandom bits specific to the time at which the data was generated, which also can be expressed in the (name) object.

Any object that is too old or otherwise does not conform to the system identifier's time template, or other security evaluation template, cannot be imported into the IPCell 700, because this initial cluster 110 acts as a gatekeeper. Within this cluster 110, the sub-cluster 20a labeled <Name:?> is causative, it implements a cause. When, e.g., an object such as (Name: Jones, Joe; (salary($1.00))) flows through the input interface 500, e.g. in a PD(Data) data block 130, the successful detection of the string ‘Name:’ in the proper role of the action object initiates a cascade of operations beginning with local validation by the cluster 110.

Data validation may include the distribution of the object such as (Name: Jones, Joe; (salary($1.00))) into multiple parallel paths of clusters of PEs 20, e.g., 20b-20d each of which performs some processing on the data, but none of which performs too much. The ISC2 system identifiers of the COP for the system 1000 can achieve this in a number of ways. First, the application system identifiers can specify the structure of this object such as (Name: Jones, Joe; (salary($1.00))). Focusing for the moment the thing (name), the system application system identifiers for (name), such as name [Name:] [(last)] [,] [(first)] [;]) can result in the cluster 110 of PEs recognizing that the thing called (name) contains a fixed field called ‘Name:’ that stands for itself, i.e., it has its own place [Name:]. In other words, nothing but ‘Name:’ goes into that place, the first place of things called (name). The next place in the (name) system identifiers expresses a place for the last name, in this simple example, [(last)], which via CLBM notation is a data thing called (last), e.g., located in an otherwise unnamed place. In CLBM, the place may inherit the identity of the thing that is located in that place, which may be a first or illustrative thing. Also by CLBM convention, (last) does not stand alone, but is part of (name), (name [(last)]) or ([(last)] name).

Since the system identifiers contains a place [,] between last and first name that is filled with the string “,”, there is an expectation that the ((last) name) will be followed by a comma. Failure to include the “,” may result in an error that the IPCell 700 corrects locally or that is elevated to the IPOverlay 950, e.g. for human intervention, as specified in the COP of the system 1000. Specifically, if a (name) object tries to enter the system 1000, e.g., through IPCell 700 input port 500, without the proper system identifiers being present, e.g., without the string “,” comma in the right place [,], such as (Name: Abu abu Ali), an exception could be raised to the IPCell 700.

The IPCell 700 could raise the expectation to the IPOverlay 950 which could provide a notice to a person entering the data and to a supervisor of that person, simultaneously, e.g. offering to insert the comma (Name: Abu, abu Ali). The data might flow from a scan of a drivers' license and not from a data entry clerk. Meanwhile, the faulty (name) object can be flushed from the <Name:?> cluster 110 and an audit trail can be created. It is possible that this particular first name has two parts that should not be separated by a comma. Human attention to this exception could result in the introduction of a revised object (Name: Abu abu, Ali;) so that the (name) object can be punctuated in accordance with the current system identifiers of the system 1000.

To keep such exceptions from happening in the future, multiple people could agree to update the applications system identifiers to reflect such cases. In other exception cases, the faulty (name) object could be encapsulated, e.g., explicitly using VM constructs such as for string objects, e.g. (Name: (String [Abu' abu']) (String [Ali])), where the (String) things of the VM are in the system identifiers of the system 1000 and can be used to train the system by using it in this way, versus reprogramming it.

Massively parallel pipelining can be used to process the (name) object once validated. The (name) object can flow into the PE cluster 112 shown in FIG. 7 to split it up, e.g., for massively parallel storage. Data farms often stripe data across hard drives to accelerate access and to provide a modicum of security, which in the case of a determined adversary may be a false sense of security. The conventional wisdom asserts that since the (name) data is striped across multiple hard drives, the loss of a single hard drive does not compromise anybody's identity.

Over time, however, a sufficiently malicious agent may collect all of the hard drives to reassemble data that persists over time, such as the names of the longest serving employees, of the best customers, etc. Such a malicious act is an example of externalized general recursion enabled by data persistence. The system identifiers of the ISC2 system can also provide striping, encryption, random striping, etc, according to the COP, but the primary protection of this invention is the death of data by default that assures that every element of data is erased automatically and by default as any chip, board, chassis, etc, of hardware is removed from operation within the system 1000, thus thwarting such malicious agents.

The striping of data across PEs can be achieved, e.g., by the expression of the system identifiers for splitting data like (name) into its constituent elements. The system identifier ({{{{(split [[(A)][(B)][(C)][(D)]]) [(A)]} [(B)]} [(C)]} [(D)]}, as shown in FIG. 7, expresses four unnamed outer level paths {( . . . )[ . . . ]} from an object named (split) that has four places to four distinct places, each of which can take the contents of one of the places of the (split) object. Path system identifiers like the {split} system identifier noted above can result in interconnections among PEs 20, such as 112a-112d that can act as the equivalent of direct memory access (DMA) in conventional processing systems.

As shown in the Information Representation (IR) clusters 110, 112 of FIG. 7, there can be a specific PE 112a named (split) that can have has four places, e.g., as illustrated in the cluster 120 by places 120a-120d, one each for things (A), (B), (C), and (D), e.g., from the (name) object [Name:] [(last)] [,] [(first)] [;]), corresponding to PEs 120a-120d respectively. An important feature of the system identifiers can be that they can be interpreted by metaphor, binding a given known case to a new opportunity. As noted previously, the VM bind action can be associated a specific need for multiplication in the application, w=s*h with a generic multiplication capability, C=B*A via the VM operation /Bind {/w=s*h\]} {/C=A*B\}\.

In the case of distributing names, the VM bind operation can be initiated, e.g., by the IPOverlay 950 to configure the portion of an IPCell 700 shown in FIG. 7, wherein can be bound the format of the (name) data object [Name:] [(last)] [,] [(first)] [;]) to the physical interconnections of, in this case, four way parallelism, e.g., in the PE cluster 120. The VM operation /bind (name) {split}\ can be used to map the four parts of (name) to the four places in the (split) PE 112a, e.g., with the associated {paths} from (split) to the respective one of the parallel storage PEs 120a-120d in the parallel storage cluster 120 of FIG. 7. The result of the particular binding operation as shown is to utilize the {split} path to control deposition of the system identifiers of the name data object (name [Name:] [(last)] [,] [(first)] [;]) into a respective one of four parallel PE clusters, 120a-120d, one each for the things ((last)name), (,), ((first)name) and (;).

Thus, when a valid (name) object is recognized and flows into the IPCell 700 through the input 500, the data comprising the name object can be stored in the IR functional b lock 100 in parallel, in this case in four way parallelism for the elements of the name object (name [Name:][(last)][,][(first)][;]). This flow suppresses the ‘Name:’ tag for this object, but moves all four of the structural elements of (name) into the parallel storage clusters e.g., 120a-120d of FIG. 7.

The storage clusters for ((last)name) and ((first)name) can serve to place the values such as “Jones” and “Joe” into the respective PE memory based transform (MBT) 40 of the functional PEs 120a and 120c. The system identifiers may specify indexing for compact storage in the MBT 40, such as using the first 10 bits of the employee number to index the MBT 40 for a relatively conventional database application realization.

On the other hand, for massive parallelism, if each PE 20 has a 10 bit MBT 40, then it can store up to 1024 values in respective [places] of 1024 memory address locations of some defined length each. With IPCell 700 level association to keep the pieces together, there could be just one character in each PE 20, such as ‘J’ in the first PE 20 of the ((last)name), ‘o,’ the second letter in the second PE 20 and so forth.

Such massive parallelism can be provided by other more complicated expressions of the system identifiers in the COP, but the principle of splitting for storage is the same as the four way path system identifier illustrated by way of an example in FIG. 7. The values, e.g., individual characters, e.g., can flow into these parallel PEs 20 where names, salaries, and associated data all can be saved in respective MBTs 40 and associated with each other via, e.g., a {path} operation and, e.g., an (employee) object scope operation of the VM.

These /scope\ actions can serve to flow the data to the right clusters, e.g., cluster 120 for storage, can be extracted when needed for processing, e.g., resulting in data flow to the output side IR functional blocks 100 of the IPCell 700 for retention until needed.

In the (name) example, the clusters for ‘,’ and ‘;’ can be utilized verify the operation of the four parallel clusters 120a-120d. If some flow attempts to move a ((first)name) into one of the clusters 120 without the associated [,] and [;] elements flowing into the defined parallel paths, this inconsistency raises an exception. The response to such exceptions varies from an audit (e.g. if the data arrives a little late), to quarantine of the (name) object, to destruction of the entire system 1000 if, e.g., multiple attestation fails to deliver corrective action in the time, space, and bandwidth resources specified in the system identifiers of the system 1000. The mathematics of reliability engineering may be applied to structure the COP to balance the probability of such failures of the system 1000 against security considerations, and the COP may be structured to preserve critical data from which the system 1000 may be rapidly reconfigured by multiple authorities with the required tools and hardware resources.

Since the system identifiers of the COP can specify a relatively large envelope for valid (data) flows, the aggressive enforcement of the system identifiers does not mean that the users will be annoyed by the self-monitoring. The system identifiers could specify, for example, that the terminating identifier “;” and thus its place “[;]” is optional. The Name: pattern still would be needed for the <Name:?> pattern match to cause a (name)-related flow into this IPCell 700, but the lack of [;] could be configured in the COP or by ML to not cause a fault, e.g., if the system identifiers included (name [Name:][(last)][,][(first)]) as an alternative pattern to the (name) pattern (name [Name:][(last)][,][(first)] [;]). In such a case, the binding operations of /bind\ actions of the VM at the IPOverlay 950 level, e.g., during system 1000 initialization, could result in the same four parallel storage pipelines, but the [;] cluster 120d not including [;] would not initiate fault processing.

If one PE 20 from the cluster 120 were to be removed, only [first] or [last] name is removed (or string or randomized bit-pattern components thereof), so that data migration would be minimum, The other PEs 20 of the cluster 120 could then preserve the data via error control coding, as is well known in the art. The removed PE 20 could also sense that the other PEs are missing, e.g., because of lack of signals at its communications signal ports C1 . . . Cn and from the resulting lack of signal correlation from its correlator 60 and can thus destroy the (name) data elements in its MBT 40 that it contains, destroying by default because there occurs a lack of nulling from the cross-correlator 24, e.g., resulting in the addition of signal generator bits to the MBT 40, thus resulting in the destruction of the data contained in the MBT 40, initially to a recoverable degree, and over time to a degree that may not be recoverable. Similarly, if tampering is detected or allowable fault time expires, subsequent destruction of data in the MBT, which may represent data or ISA or both, per the system 1000 COP, may not be recoverable.

A portion of an IPCell 700 including a cluster 710 of PEs 20 for calculating weekly salary, as an example, is illustrated in FIG. 8. As with the IR functional block 100 discussed above, the cluster 710 of PEs 20 can process data via asynchronous parallel pipelines that can be constructed according to the system identifiers aggregated into the COP of the system 1000. The system identifiers of this portion of an ISC2 VM 1000 can contain a pattern for performing a multiplication function: COP (/*[[A][B]] {[(A)][(B)] [/C=A*B\] [(C)]}\). This system identifier means that the action to multiply /*\ is a (thing) that requires three places for data. The first two places, [A] and [B] are the operands, while the third place, [C] contains the result. The format of this system identifier is illustrative, not normative, but the semantics are normative. This part of the system identifiers expresses what in conventional architectures would be a subroutine, which here contains a {path} that connects the operand values (A) and (B) to a result (C) according to a defined action, such as a multiplication action /C=A*B\.

The salary payment application can use this function because it occurs in the system identifier of the application, e.g., {(weekly[w]) (hours[h])(salary[s])/w=s*h\}. Here, the action pattern /w=s*h\ is analogous to the action pattern /C=A*B\ for the multiplication function. The VM action occurring at the IPOverlay 950 level of abstraction can be utilized to /bind\ these two patterns to form the configuration of PEs 20 illustrated in FIG. 8 within the portion of an IPOverlay 950 illustrated in FIG. 8 using, e.g., an IPCell 700 in the particular IPOverlay 950, e.g., to set up its parallel pipeline of PEs 20 to perform this function is illustrated.

A generic form for the multiplication of two numbers requires a specific action, /C=A*B\. For an MBT 40 realization of multiplication, the system identifiers in the COP can contain a lookup table or circuit specification that can associate, e.g., a bitmap of A and a bitmap of B as inputs with a bitmap of the result C as an output. In a field programmable gate array (FPGA) realization, a previously validated and digitally signed circuit specification for addition could also be provided in the system identifiers to reduce power and improve efficiency, e.g., by performing addition of A+A for B times to multiply AXB.

For maximum security, however, an MBT 40 lookup table could be specified as follows:

TABLE 1
Binary Multiplication Table (illustrative)

| Value of Input A | Value of Input B | Result C |
|---|---|---|
| 0000 | 0000 | 00000000 |
| 0000 | 0001 | 00000000 |
| 0010 | 0010 | 00000100 |
| 1000 | 1000 | 00010000 |

Four bit nibbles as input each represent the unsigned binary constants 0 through 15 decimal as 0000 through 1111 binary. Since zero times anything is zero, the sixteen results for C are zero whenever A is zero regardless of B's value. In all, 16×16=256 values can be stored in this table for 4×4 bit binary multiplication yielding 8 bit unsigned products. The other two bits of a 10 bit address field can be used to realize additional functions, such as addition, subtraction and division with, for example, the leading two bits of a 10 bit address in the function of an operations code, 00 for addition, 01 for subtraction, 10 for multiplication (as illustrated above) and 11 for division. In this simple example, a PE 20 designated as a PE* 720 in FIG. 8 could contain such an MBT 40 lookup table which can have been synthesized by the IPOverlay 950 when the system 1000 was configuring itself, e.g., at power up, and/or in the factory. This approach of integrating hardware and software functionality together in the same initialization/factory configuration process can avoid degrees of freedom which can open implementations to malicious agents. As an example, factory integration of applications functionality (expressed in the applications system identifiers) with generic system functionality (expressed in general capabilities of the system identifiers, such as, multiplication) can serve to protect the security of functionality better than existing approaches. As an example, for critical capabilities such as banking and critical infrastructure like electric power grids, the security provided by the architecture according to aspects of embodiments of the disclosed subject matter can be very beneficial.

In other parts of the ISC2 system 1000, the system identifiers could pack more kinds of operations on shorter operands into the same 1024 bit lookup table. In fact, there is no function of ten bits having an 8 bit result that cannot be stored in an lookup table having a 1 kbyte address space. For some applications such as email, 1 kB lookup tables could be ideal, resulting in literally thousands of such PE's 20 per chip where each PE 20 contains one character of the email stored in one location indexed via the IPCell 20 as described previously.

For other classes of applications such as banking, the system 1000 could utilize a mix of 1 kB and 1 MB lookup tables with the 20 bits of input of the 1 MB MBT 40 providing greater flexibility for simpler PE 20 to PE 20 interconnect functionality than with a 1 kB realization. There are design and implementation tradeoffs regarding the kinds of functions to be performed in a given collection of MBTs 40 that could result in different system identifiers even for generic operations like multiplication.

Signal processing applications might employ a lookup table, such as Table 1 early in the processing of digitized data, opting for floating point operations in later phases. Even floating point operations may be realized via well known distributed parallel pipelines. Optimization of such operations via genetic programming (GP) generates many random possibilities, selecting among the best and combining the best results in subsequent generations to yield optimized constructs, in some cases similar to a RISC architecture, while in other cases more compact and efficient than could be hand coded, as is well known in the art, e.g. of circuit placement on processor chip layout optimization, and could be the kind of tool suite employed in the factory to map a specialized application like radar signal processing onto a system 1000 sized to accommodate it with room for growth, e.g., including tens of thousands of PEs 20 organized via system identifiers generated using GP-based optimization tools.

As discussed in some detail above, a payroll processing pipeline can contain several clusters of PEs 20 including an applications cluster 730 shown in FIG. 8, and a generic multiplication cluster 760, also shown in FIG. 8. These clusters 730, 760 can cooperate to create a core payroll processing pipeline of clusters designated as (split) 724, (PE*) 720 and PE[(weekly) 722 in FIG. 8. These are created by the IPOverlay 950 at system synthesis time when, e.g., a VM bind action can associate a specific need for multiplication in the application system identifiers, w=s*h, with the generic multiplication capability, C=B*A required to implement it via the VM operation /Bind {/w=s*h\]} {/C=A*B\}\.

Such an IPOverlay 950 VM operation can be equated to system functionalities. A source of generic PE 20 resources can becomes constrained by an IPCell 700 system identifiers for the IPCell's 700 clusters of PEs 20 to express the clusters of system identifiers, e.g., as shown in FIG. 8. Binding action can then instantiate an application cluster of PEs 20 in the IPCell 700 to realize and monitor, e.g., a path {/w=s*h\]} while a more generic set of PEs 20 can realize and monitor a more generic multiplication function {/C=A*B\}, wherein /w=s*h\ is specific to the weekly pay application, while /C=A*B\ has no a-priori application association and thus is more generic.

These functional capabilities can be realized as paths because at system configuration time there can be the potential for data to be processed at some point in the future, but data is not yet flowing in the system. Flows of test data sets can be included at the system 1000 instantiation in the fabrication process, from very early in the configuration process The flow of representative data in the system can optimize the use of the available resources, e.g. via GP and embedded machine learning at the level of the IPOverlay and groups of IPOverlays. This can include external design, configuration, and test tools. This might also be accomplished by using system simulation and emulation tools.

Once a pipeline, e.g., as shown in the blocks 724, 722, 720 in FIG. 8, has been allocated to PEs 20, clusters of PEs 20 can be established to, e.g., look for the object that initiates, e.g., weekly payroll processing, e.g. for an employee “Joe Jones.” In the above discussion of the IPCell 700 of FIG. 4, the object (Name: Jones, Joe (time card (hours(40 hr)) (date (Mar. 31, 2011))) initiated payroll processing for the employee “Joe Jones” because, e.g., the object (Name: Jones, Joe (time card (hours(40 hr)) (date (Mar. 31, 2011))) provided a digitally signed packet of data with the data needed for the action /w=s*h\. The IPCell knows this from the system indicators of the COP as in the legend of FIG. 8.

Since an ISC2 system 1000 according to aspects of embodiments of the disclosed subject matter can be based on parallel pipelines of small processors (PEs 20), processing clusters can look for missing data such as (hours[h]) all the time if that function is allocated to a processor by the IPCell 700 based on the COP, e.g. based on the availability of many such PEs 20 in a massively parallel pipelined chips set, and based further a lack of specific power constraints imposed either directly via the COP or indirectly, e.g. via ML. Alternatively, to save power, PEs 20 that are not doing useful work can turn themselves off or may be turned off by the IPCell 700 or the IPOverlay 950 of which they are a part.

In this example, (Name: Jones, Joe (time card (hours(40 hr)) (date (Mar. 31, 2011))) can appear in the signal processing flow or PE(Data) blocks 770 of FIG. 8. The causal PE 772, designated <weekly?>, may form a flag to initiate processing. It might be possible to issue a generic query to the clusters 730 of a payroll IPO 950, e.g., via a query object like (query [(weekly? [(% complete)])]) that can invoke processes (not shown) to report on how many of the company's employees have had check amounts computed so far.

In this particular example, the <weekly?> causal PE 772 can also look for a (time card) object inside a cluster of PEs 20 that can trigger the extraction of 40 hours, validating the units hours in parallel with computing the (weekly) amount as illustrated by the pipeline 724, 722, 720 of FIG. 8. This process can begin in the PE 20 cluster (split w) 724 that extracts the number of hours worked, flowing it into a PE (hours) cluster 726. In parallel, the PE (salary) cluster 728 can retrieves (name(Jones, Joe)) salary from the (Joe Jones) object in the IR functional block 100 of the IPCell 700 containing the clusters shown in FIG. 8, which can have accreted into existence over time within the IR functional block 100.

At each point in this process, the flow can be continually subject to the parallel verification, e.g., of signature bits simultaneously as discussed above. Once the hours (h) and salary value (v) are in the input places 732, 734 of the multiplication PE (PE*) 720, the conditions have been met for the product to be computed, e.g., in the next succeeding clock cycle after such readiness is established.

The time lines for such clock cycles may be tight because termination PEs are observing the progress of the functional PEs like (PE*) 720 to assure that their behavior remains within space-time-bandwidth constraints specified by the system identifiers. However, the finite time delays of monitoring and of the functions being monitored may be in conflict, e.g. if the monitor process takes longer time than the monitored process. Synchronization of the results of all such PEs 20, with functional and monitor roles is a key function of the final IR functional block 100 of an IPCell 700, such as is illustrated on the right of FIG. 4, further assured by the cross-checking of output interface functional block 500 of the IPCell 700. The result of the multiplication in PE cluster 720 flows to the (weekly) PE cluster 722 where it is retained for a time interval specified by the system identifiers.

The retention period can be made to be consistent with the application. Thus, a weekly paycheck amount may be retained in the IPCell 700 that computed it only long enough for payroll processing to be completed. Payroll data may be accumulated and retained in encrypted storage in other PEs 20 (not shown). The parameters of these other PEs 20 may be tuned for the longer term storage, such as location for greater physical protection via multi-location backup. In such instances, ⅓ of the bits, randomly selected, may be stored in one physical location while another third is stored elsewhere and the final third is stored at a third location.

Other accounting pipelines may grow from the ones shown in FIG. 8, e.g., to compute withholdings, etc. Thus, there is no “applications program” per se after the system is configured. Instead, the application can have been synthesized according to the system identifiers, e.g., via distributing the functionality out to other parallel pipelines tailored to the application, in whole forming so called massively parallel pipelines, which, again, can comprise asynchronous pipelines. The result can be a high performance transaction-processing system where there is nearly imperceptible processing time delay between data coming into the system 1000 and results being available. This characteristic of the ISC2 system 1000 hardware architecture can result, in addition, to absolute security, in the ISC2 system 1000 providing response times that do not depend on bottlenecks, e.g. between processors and memory. The MBTs 40 throughout the system 1000 can function as memory or table-driven processing. Such distributed application synthesis can optimize the delivery of hardware processing and storage capacity to the applications.

At the lowest level of the system 1000, the ISC2 system 1000 can compute via the processing elements (PEs) 20 illustrated in FIG. 3. Each PE 20 can recognize a data set PE(Data) offered at the input 50 of the PE 20. The data may be in any format, but can conveniently conform to a data communications protocol, such as Ethernet and the like protocols, i.e., including data packets containing data and other type identifier, source identifier, destination identifier and like indicators in the frames of the packets. Validation of the data set, such as PE(Data) by the PE 20 can occur by the distribution of functionality across multiple PEs 20 by the IPCell 700 of which they are a part.

Some clusters of PEs 20 such as those labeled COP in FIG. 4 contain the complete set of system identifiers referred to in aggregate as the COP, or some sub-set of these, and embedded in the MBT 40 of each of the PEs 20 of the COP blocks. Since the system identifiers of the COP can require megabytes of storage, a system identifier COP in each IPCell results in the use of multiple PEs 20, e.g., each with a 1 MB MBT 40 configured for COP storage and specifically precluding its alteration except via extermination of data if the PE 20 is removed from the system 1000 as indicated by anti-tamper sensors 32, power sources 30, or lack of channels C1 . . . Cn 60 of FIG. 3.

The operation of the PEs 20 of a system identifier cluster of a block labeled COP in FIG. 4 can be connected to adjacent system identifier storage PEs 20 within the same COP block via the inputs 50, outputs 52, and/or communications channels 60, i.e., C1, C2, . . . Cn of adjacent PEs 20. In addition to the correlation function shown in the flows of FIG. 3, the interconnected PEs 20 may link their inputs via synchronization of flows external to the particular processing PE 20.

In other words, the input 20 of one PE 20 may be logically concatenated to the input 50 of another PE 20 via the correlation process. This can occur, for example, in the relationships among the input frames of PEs 120a-120d of FIG. 7. Although (Name:[Last],[First];) is the sequential format of the (name) thing and may be its physical structure when in motion in PE(Data) 130 of FIG. 7, the data has been distributed across PEs 120a-120d so that the name data appears in the concatenation of (last), (,) (first) and (;) across the inputs of PEs 120a-120d in FIG. 7 as an example.

This distribution effect can allow, e.g., a dozen 10-bit MBTs 40 from a dozen PEs 20 to form 120 bits of input processing distributed across the 12 PEs 20. The physical adjacency could conform to generally accepted practices for reliable systems, such as coding data across the data, e.g., organized into packet frames and subframes, and dealing with the incoming input packet frames, so that, if any one of the 12 subframes is absent, the error control properties of the respective MBT 40 can correct the resulting error. Similarly, such a cluster of 12 PEs 20 may be organized so that, e.g., removal of one physical module, i.e., a daughter board containing 16 chips of 100 processors each or 1600 processors, may remove one PE 20 from several clusters, but would not remove any entire cluster.

Once an input data packet is synchronized, the bits from that input data packet frame can be accessed by the MBT 50 of the PE 20, e.g., presenting 10 bits to the MBT 50. The MBT 50, using a lookup table (not shown), can then, e.g., use the input data packet frame bits as an address to retrieve the further data addressed by the 10 bits. This accessed lookup table data stored in the lookup table, can then be deposited into the output frame 52 of the PE 20, e.g. in the next clock cycle.

Using a 2 bit operations code (opcode) and two four bit nibbles as arguments, four independent binary operations that input two nibbles and output one byte each may be synthesized, such as addition, subtraction, multiplication, and division as discussed above. In addition extremely computationally intensive nonlinear operations also may be stored in the memory, e.g., as stored in the MBT 40 of a PE 20, so that the results of such operations need not be computed, but can be produced instantly from the input arguments presented in the input 50.

For example, the opcode 00 could be configured not for arithmetic, but for the production of the maximum of two operands by storing 1100 into the memory position 11000001, which yields the maximum of the operands 1100 and 00001 from the MBT 40 lookup table of position 11000001. Loading the address range from 00000000 to 11111111 with 0101, transforms all combinations of arguments into the binary number for the integer 5. Such may be, e.g., a nonlinear operation used in some filtering operations. In fact any conceivable function of two nibbles as input and one byte as output may be computed in this manner, which is the expressive power of the MBT 40.

Since the system identifiers can aggregate clusters of PEs 20, e.g., containing 16 such PEs 20 (e.g. without introducing timing races across PEs 20), the system 1000 may be used to synthesize 32 bit arithmetic in parallel. Carry bits, flag bits (e.g. for division by zero) can be handled by associating an additional PE 20 for these functions, synthesized via lookup table as well. This is known to be possible because any binary logic function may be synthesized via a lookup table.

For example, the multiplication of one 32 bit integer times another 32 bit integer to yield a 64 bit result may be distributed across four twenty bit MBTs 40 via well understood combinatorial logic. To see how this works, consider multiplying one four bit number, e.g., 0110 binary (=6) times another four bit number, e.g., 0110 to yield a four bit result. Since 6×6 yields 100100 (=36), there is an overflow. Numbers greater than 1111=15 cannot be represented in 4 bits, so the product 36 must be hard limited to 15 and an error condition must be generated, UNK in the CLBM model since 36 is unknown in 4 bit arithmetic. As another example, multiplying 0111 (=7) times 0010 (=2) yields 1110 (=14), and this is within the range of a four bit result.

The four bit multiplication may be achieved by multiple PEs. First, the four bit operands are /split\ into two pairs of two bits each, the least significant pair (LSP) 11 of the first operand (0111=7), and the LSP 01 of the second operand (0001=2). One PE multiplies the least significant two bits times each other (yielding 11×10=110 binary) to generate the least significant bits of the result (10=2) plus a carry bit (=1 in this case). The second PE 20 multiplies the most significant pair (MSP) 01 of the largest number times the LSP of the smallest number to yield the intermediate product 10, and a third PE to add the carry bit to this intermediate product. Thus, the most significant bits of the product (11) paired with the LSP product 10 yields the result 1110=14.

Instead of 2 bit arithmetic, each typical PE 20 MBT 40 may use ten bits of input to compute the product of two 4 bit numbers, so three ten bit MBTs 50 may compute the product of two 8 bit numbers, or three 20 bit PE MBTs may compute the product of two ten bit integers in a three PE 20 pipeline. This type of parallelism scales up to arithmetic on 64 bit numbers, e.g., using 7-way partitioning of 10 bits each along with additional interim product and carry-bit registers.

The lookup table of an MBT 40 may accept a bit pattern such as two pairs of input nibbles and a switching opcode, e.g. (0000111100) where all bytes represented by the first eight bits, assuming the last two on the right are the opcode, are to be transferred without switching, so the MBT 40 output also would be (0000111100). The MBT 40 may also contain in the MBT 40 storage location addressed by the input (0000111101) a bit pattern of (1111000001), which becomes the output on output 52.

In such a case, as an example, the right most two bits in the input (01) can be the opcode, indicating that the function being performed is a switch of the subsequently received two nibbles (00001111) to the opposite position in the output, so the output bits stored in the location addressed by the two nibbles 00001111 are 11110000, the outcome of a switch function as so defined on the input data.

By storing such results in all possible addresses in the MBT 40 lookup table, as defined by the combinations of the two input nibbles, the MBT 40 may act to perform the switch function on the two nibbles of the input data. The 00 and 01 codes use up half of a 1024 byte memory, so other switching operations are possible such as suppressing one or the other nibble, allowing only one of the two nibbles through. For switching applications the output 52 can then be imparted to the input 50 of a follow-on PE 20 where the opcode flag bits may be ignored or may result in a completely different operation on the data represented by the two nibbles. As an example, one of the number of functions, i.e., (/actions\), noted above The switching fabric between and among PEs 20 could be in accord with the operation of an N-cube so that any PE 20 is only a small number of PE 20-PE 20 paths from another given PE 20.

Each PE 20 can embed correlators 60 as well as the tamper detection and on-board batteries, so that each PE 20 may continue to operate as long as the on-board batteries permit, if required to do so. These may be sized, e.g., for hours of operation. Each PE 20 can monitor its batteries and tamper sensors 32, destroying itself if criteria are met that are consistent with removal of the PE 20 from the system 1000 (e.g. failure of correlation, tamper alarms with failure to connect to all of the previously adjoining PEs 20, etc). Consistency of computational behavior can be achieved by associating multiple PEs 20 together to express a specific segment of the system identifiers within the COP for specific functions. Continued monitoring of the resulting clusters can assure that the cluster(s) does exactly what the system identifier for the cluster specifies, no more and no less.

The system identifiers and VM distribute finite functions across PEs 20 into self-referentially consistent data streams. A keystroke interface, for example, is supposed to consist of the hardware driver, interrupt service routines (ISR), and a set of listener functions that respond to keyboard activations, e.g., to provide visual feedback by displaying the characters associated with the keystrokes onto a display screen. Malware may insert itself between the driver and the listeners, e.g., in the interrupt service routine, to redirect keystrokes to an unauthorized logging function. Although there are patterns for known classes of keystroke loggers, hackers regularly create new kinds of loggers, such as the SAP banking application logger that impersonates a legitimate SAP banking application, where SAP is the market dominant banking application.

The conventional approach to security is to allow a signed application to run as the default that promotes Internet commerce, proliferating malware. The system identifiers of the ISC2 PRF-SAOS specify paths by which keystrokes originate in the user interface IPOverlay 950, transit through specified IPCells 700 for driver functions (e.g. hardware code mapping from binary patterns to a character code, key de-bouncing, code conversion from keyboard code to system character code, etc.), and for what conventionally would be ISR, but in the ISC2 system are the parallel pipelined paths from the device driver to the various keyboard listeners. A COP expression {[(keyboard [keystroke(keycode)])]Vdebouncel[/decode\][500][900] (5,5,1)} specifies that a keystroke originates as a keycode that is debounced, decoded, and abstracted up to the IPCell's input interface 500 and thence up to the IPOverlay 950 interface 900 for availability to applications, providing space-time-bandwidth resources (5,5,1) consisting of 5 PEs 20 of space and 5 clock cycles (one per PE 20) of time delay, at a processing bandwidth of 1 GHz clock rate.

Since the five functions identified to the system in this path each require at least one MBT 40 lookup in at least one MBT 40 clock cycle, PEs 20 may be assigned to monitor each of the actions (e.g. /decode\) for behavior and resource use in its associated places (e.g. keycode input into the functional PE's 20 input 50, one MBT 40 lookup time, and (decoded) keycode output at the functional PE's 20 output 52. The monitor PEs 20 for the [/decode\] place of this path can have been configured by the IPCell 700 to monitor the constraints (5,5,1) allocated to the PE 20 performing the /decode\ action, e.g. constraints (1,1,1) for this PE 20.

The monitor PEs 20 of the IPCell 700 can continuously evaluate the PEs 20 behavior for compliance to resource (1,1,1) use constraints as described, for behavior derived from the characteristics of (keycode), such as consisting of 8 bits (or 16 bits for Unicode, etc, as defined in the COP). The behaviors and tight constraints may be learned and validated during system 1000 configuration and test time, such as exactly how many PEs 20 and exactly how much time delay through this pipe, with what functionalities in each assigned PE's 20 MBT 40. Once established for an operational system, software, hardware, and people cannot change any of this, but, rather, it must be changed at the factory via a new COP.

This defines a “Model T” approach to commercial computing versus a “canvas on which to paint.” In other words, once the COP is defined at design time and that COP is flowed down onto a collection of thousands to millions of processor PEs 20, paths like the (keycode) transformation path described above are determined. In order to insert malware into this flow, the malware must create processing and data storage resources in excess of those specified and must defeat multiple PEs 20 that are constantly and independently monitoring the functional PEs 20 with respect to their own copy of the COP, with regular authentication of the environment as previously discussed.

Each COP-certified application behaves according to its own path from the User Interface IPOverlay's 950 input functional block 900 for the (keycode) thing, defining a path through the application that retains a copy of the (keycodes) associated into strings, etc, as defined by the applications' system identifiers of the COP, which cannot be changed after deployment. The COP has no infinite loops like operating system kernels, but wakes up {paths} and PEs 20 in the paths when needed, shutting down and powering down the PEs 20 when not actually in use. Memory not in use per the COP is written over by the signal generators 22 of individual PEs 20 to destroy data that is not specifically authorized by the COP or needed for ongoing functionality of a given PE 20 at the time. Therefore, the ISC2 system 1000 employs the COP to achieve finite, primitive recursive self-referential consistency.

The system identifiers of the COP specify the resource bounds (space, time, bandwidth) that constrain PEs 20 to single MBT 40 lookups between input 50 and output 52 at a given clock rate to achieve these paths. PEs 20 of the associated clusters of PEs 20 interpret the COP path expression In addition, the continuous monitoring of all functions down to the lowest level of arithmetic in the system 1000 can assure complete, consistent self-awareness. There may be tens of thousands of PEs 20 organized to perform a typical total primitive recursion, without using general recursion, e.g., via the classes of instruction that define the ISA.

An illustrative embodiment incorporates system identifiers in the COP that define the following classes of instruction: Sensing, Signal Generation, Timing, Correlation, Scope, Link, Thing Structure (Vector, String, Array, Hash-Table), Block-Move, Memory Based Transform (MBT), Arithmetic, Logic, Block-End, Choose-End, Iterate-N-End, Call-Return, Try-Catch-End, Bind Metaphor, Sleep, Quarantine, Scramble, Question, Attack, and Kill. An instruction template includes a core /action\, but unlike conventional ISA, each instruction operates only on (things) within narrowly defined classes called domains that are specified by the /scope\ instruction, and each instruction template specifies the things, places, paths, actions and causes with resource constraints by which finite transformations of a finite collection of things in a domain may be achieved.

This limits computing significantly. For example, it is not possible to iterate the solution of a two point boundary value problem until some error bound is met because this requires unbounded iteration. However, such applications are not needed for banking, email, or even radar signal processing, and other applications where, e.g., real time constraints force one to define the number of iterations allowed in advance. Thus, there is a top-down flow from the systems engineering of the system 1000 into the COP that forms an applications-specific ISA employing general classes of instruction in a form that is limited by the system 1000 computational needs. This allows the COP to guide the synthesis of very tight, very aggressive enforcement mechanisms on essentially every instruction in an entire system consisting of millions of lines of code distributed across potentially billions of massively parallel processors, arrayed PEs 20, which is termed exascale computer engineering.

Unlike conventional ISAs, the ISC2 system 1000 ISA can perform many instructions concurrently without having been programmed specifically in advance to do so. The interpretation of the COP is driven by the system level system indicators to configure available PEs into IPOverlays 950 and constituent IPCells 700 to realize functional flows in parallel pipelines, and to synthesize PE 20 clusters that constantly monitor functional PEs 20 per the COP. Thus, many fixed parallel pipelines result, A fine grain massively parallel multiprocessing system is rendered self-referentially consistent, fully observable, and fully controllable via the embedding of multiple identical copies of the single COP into each IPCell 700 in the system 1000. The resulting parallel pipelines operate in parallel as data is created (e.g. at a keyboard), flows into and through the system 1000 to produce real-time results (e.g. keystrokes echoed onto a display), and to retain resulting data structures for not more than the time specified by the COP.

Some classes of instructions are termed autonomous instructions, such as sensing. Sensing actions occur constantly and cannot be turned off by users, systems administrators, or managers. Repeated attempts to turn off, disable, or in any way interfere with autonomous instructions can result in system 1000 self-destruction. Additional autonomous instructions, such as Sensing, Signal Generation, Timing, Correlation, Scope (establishing domains), Link (defining parallel pipelines), and Thing Structure (verification of thing properties during data flow actions) can operate involuntarily to assure self-referential self awareness. The autonomous instructions Sleep, Quarantine, Scramble, Question, Attack, and Kill can operate autonomously to preserve the (self) responding to the detection of anomalies.

All instructions that are not autonomous are termed discretionary. The ISA relationships illustrated in the figures ultimately flow down to the smallest indivisible hardware entity (e.g. an on-chip processing element 20 (“PE”)), and one chip may contain multiple PEs 20, typically hundreds of thousands to millions of PEs 20 per chip with their associated MBTs 40, unique random signatures 54, anti-tamper sensors 32, rechargeable power sources 30, inputs 50, output, and channels 60. Over time, a chip could contain millions of PEs. This is limited by the number of bits needed per input 50 and output 52, which drives the MBT 40 memory size. A total of 10 bits in the input frame and 8 bits of result from MBT 40 requires 1024 bytes of MBT 40 memory, 1 kB, about 10,000 transistor circuits. A chip capable of 10 million transistors on chip circuits therefore can provide about 1000 such PEs 20.

However, on-chip memory for the MBT look-up tables for a 20 bit input frame and 16 bit output frame requires 1 MB address space with 2 bytes per MBT 40 lookup table location or 2 MB, approximately 20 million transistors, which is just about the capacity of a contemporary chip, without including another million transistors for the channels 60, correlators 24, signal generator 22, etc. Thus, today's chip fabrication technology can contain hundreds of 10 bit PEs (e.g. in a 10×10 array), while thousands of such PEs require additional semiconductor advances, e.g. as envisioned by the Semiconductor Industries Association (SIA) technology roadmap. In addition, multiple chip chipsets can be employed to increase the number of parallel processing PEs being used.

All of these MBT 40 memories in deployable machines would be read write to assure death of data and destruction of the system 1000 by autonomous operation should the buyer attempt to reverse engineer the system, take it apart, etc. Factory infrastructure in which systems are configured, in which COPs are instantiated for applications, etc., could include MBTs 40 with hard wired look-up tables for generally well understood open source, open architecture blocks, such as IEEE standard floating point arithmetic.

Any proprietary functional blocks could be encrypted on factory hard drives, striped across read/write MBT 40 development systems, and protected from insider threats via the entire suite of interlocking layers 82, 158, 160, 162, 156, 154, 152, and 150 of the ISC2 Enterprise system 1000 of FIG. 1. The factory owner, board of directors chair, and chief programmer all would have to agree (mutually attest to the system) in order to make any change to the factory COP. At first this sounds arduous and unworkable, but a commercial COP would support a wide range of applications in a given market, such as banking, email, airport operations (including radar), etc, any instance of which may be optimized for hardware cost versus robustness and configured accordingly with a deployment COP tailored to the mission system, without changing the factory COP that produces a variety of mission systems on a variety of hardware and communications platforms over time.

According to aspects of embodiments of the disclosed subject matter, a primitive recursive function (PRF) instruction set architecture (ISA) can be applied to limit computing to a tightly bounded subset (TBS) of the primitive recursive functions (PRF), terminating all defined computing in a known finite time. As an example such, open ended and thus undefined temporal instruction control loops such as the “WHILE” and “UNTIL” loops of conventional software practice and the related hardware looping mechanisms that underlie such unbounded looping are prohibited in the disclosed architecture. The TBS PRFs of the disclosed subject matter may constitute a bounded subset of the GRF without such unbounded loops of any sort, internal or external. The TBS PRFs can consist of data representation, the coding of information via analog forms, via time delay, and via digital forms such as the binary numbers, arithmetic (analog and digital), sequential logic, reasoning by metaphor (movement of things inside the system that have a 1:1 relationship to external things, such as in a video game), and tightly limited finite looping (e.g. Iterate N hardware, FORTRAN DO loops where I=1,N, etc.).

Such TBS PRF computing is known to be “total,” i.e., to return some concrete result in a specified amount of computing time and or space-time for any and all calling parameters. Current ISAs include and appear to require such unbounded loops and data persistence, such as in the operating system (OS). The novel ISA according to aspects of embodiments of the disclosed subject matter can define a fundamental method to completely exclude and aggressively prohibit the GRFs in order to synthesize computing entirely via TBS PRFs, both directly via the ISA, and indirectly via aggressive loop detection in computing and protocol stacks with the prohibition of unbounded-loops at all levels including the OS, external communications, and user interactions.

The disclosed subject matter is the first to synthesize a TBS PRF ISA Cluster, e.g., the functional block 800 as illustrated in FIG. 5 to mechanize a PRF architecture as shown in FIGS. 4 and 5. A TBS PRF SAOS, TBS PRF communication, a TBS PRF application support environment, and TBS PRF user access all flow from the TBS PRF principles, consistently realizing an ISC2 system 1000. Therefore computing is defined on all finite parameters (i.e., is “total”). The hardware, software, and communications mechanisms that can realize a TBS PRF-ISA according to aspects of the disclosed subject matter include the PE 20 of FIG. 3.

Power sources 30 and anti-tamper features 32 can be embedded into a PRF ISA to assure that the PRF ISA may be powered internally for a substantial amount of time after primary power has been removed from the system 1000. Power-off detection and anti-tamper initiative mechanisms can systematically corrupt and destroy data after external power has been removed from the system or upon detection of any other unauthorized manipulation of mechanical, electrical, or physical parameters. For example, in some embodiments anti-tamper sensors 32 may detect abnormal electrical, magnetic, or electromagnetic fields, bursts of radiant energy, and other indications of a threat to the integrity of the system 1000.

Signal generators, such as 22 in FIG. 3, within multiple ISA PEs 20 of information processing cells, IPCells 700. can synchronize their clocks and initiate a complementary finite interval lasting for a small and strictly limited amount of time, such as 1 microsecond. This information processing work period can be used to create a set of Nf work periods to constitute a work cycle. Each work cycle can be initiated with a synchronization work period. In this synchronization work period, the signal generators 22 can, e.g., pose a random challenge (RAND) to the ISA's response signing function, from which a signed response (SRES) can be generated and by which the signal generators 22 can issue the random challenge to the cross-correlators 24 and initiate a guard timer. Cross-correlators 24 can access external signal paths to assert the RAND, and to compare the resulting SRES bit-by-bit serially or in parallel.

If the SRES provided on a given external communications path Ci (1<i<Nc) does not match the SRES provided by the signal generator 22, then external communications on path Ci can be blocked. Nf, the number of work periods in a work cycle, can be set by the IPCell 700 of which the PRF ISA is a member in order to coordinate the flows among the ISA functional blocks, such as 970 in FIG. 2, in a bundle constituting an information processing cell, IPCell 700. The functional blocks, such as functional block 970 of IPCells 700 forming IPOverlays, such as specifically the Time Card IPO 954 and the Salary IPO 952, both of which, for illustration purposes support the IPOverlay 956 that Prints Checks.

The functional block 970 shows how hardware PEs 20, shown in FIG. 2, may be optimized for processing functions, for memory functions (M 80), and for interconnect functions, IX (not shown), for simplicity, but suggested by the dotted lines of 970 indicating that these PE 20 and M 80 functions are interconnected. The functions of the TBS PRF SAOS of operation 92, observation 94, and reaction 96 summarize briefly the nature of the IPCells 700 subordinate clusters of PEs 20 (not specifically shown in FIG. 2) operating autonomously within the IPCells 700 as specified by the system identifiers of the system 1000 COP.

The functionsI block 970 may not exist entirely within one chip, but must be distributed across multiple chips and boards of a single-box system 1000, or across multiple boxes in a larger system. The distribution of PE 20 and memory 80 collections 970 across multiple physical devices assures the awareness of each PE 20 of the physical state of the larger system 1000. IPCells 700 may become aware of the disconnection of the IPCell 700 from the larger system 1000 via the lack of correlation of a specific PE 20 that no longer receives an appropriate signal via a channel Ci 60 that is connected to a PE 20 on some other board or in some other box of the system. There need be no functional relationship among such interconnected PEs 20 since the purpose of such channels is to physically verify the presence of the entire system 1000 via the interconnections among PEs 20 of the disclosed subject matter.

PRF ISA noise cancellation can be utilized for noise-free information processing. Normally, during a work cycle, the streams generated by the signal generator 22 plus all active correlator 24 channels, received from the signal generators 22, can be added together with the content of the input 50, the memory based transformation, MBT, unit 40, and output 52. If all clocks remain mutually authenticated, active, and synchronized during the work cycle, the binary sums from the cross-correlators 24 and signal generators 22 cancel each other perfectly, allowing the MBT 40 to receive undistorted data from the input 50, proceed with an undistorted conversion of the data. e.g., through the MBT 40 look up table, and delivery of the data to the output 52 for the work cycle. Thus, a defined amount of MBT 40 processing is performed during such work cycle.

The unique random signature, (URS) 54, and the derived cryptographic parameters that are not perfectly cancelled may cause linear and nonlinear operations on the MBT 40, redefining data, such as causing linear addition, causing indexed permutations or causing state-dependent nonlinear combinations of data that are difficult to reverse, such as traversing elliptic curve maps. When Ci bitstreams 60 are not cancelling each other, a fraction of the bitstream content can distort the MBT 40. PRF ISA, such as in functional block 600 to IPCell 700 streams can indicate a lack of cancellation in the IPCell 700 to the IPCell 700 input/output interfaces 500. This may intercede to reverse the process, or may allow cancellation to continue until the functional block cluster 600 is destroyed completely via successive distortion operations. The IPCell 700 may be reclaimed for future use e.g. via zeroizing MBTs 40 in the PEs 20 making up the IPCell 700.

An MBT 40 may also be realized with a content addressable memory (CAM), a look aside (LA) translator, a certified PRF field programmable gate array (FPGA), or a constrained conventional instruction set with no while or until loops and with embedded on-chip memory. Each such MBT 40 can, e.g., append a clock reference and cryptographically encoded audit trail to the transformation results to create a self-referential process packet (SRPP). SRPP's may contain not only data, but also information, e.g., in appropriate frames, indicative of a time stamp for the transformation and the identity of the MBT 40 doing the transformation, where the data that was transformed using the MBT 40 lookup table was sourced, and what its destination is, as is well known in the art of packetized data transmission.

AnMBT 40 can realize computing by looking up input data associations in the memory, e.g., in the MBT 40 lookup table, in order to yield output data or by performing compactly represented equivalent PRF functions such as integer arithmetic within a work cycle. The last output 52 of the work cycle can also be used to encrypt the output data at the output 52 so that complementary decryption can be required in order to process the data in the output 52 as input data in an input 50 to another functional block, such as 970.

Information representation (IR) functional blocks 100 in an IPCell 700 can be PRF ISAs also configured to provide associative memory. Memory access can be mediated by the work cycle in which a memory reference in an Input 50 is provided to the MBT 40 for processing. A memory reference may cause data to be retrieved from memory, where the MBT 40 treats a memory reference as an associative index or key, e.g., to a lookup table. A memory reference may cause data to be stored in memory. A memory reference may augment the MBT 40 with a new associative structure. A memory reference may read-modify-write, saving an associative input into the MBT 40, while providing the existing value as the result on the output 52. Finally, a memory reference may perform a null operation on the IR 100 in a single cycle, delivering the content of the input 50 to the output 52 without modification.

With each memory reference the MBT 40 can update a self-referential control bitmap of the MBT (for simplicity not shown) that identifies each memory location containing stored information (e.g. with 1) and not containing useful information (e.g. with 0) so that there is no unaccounted for space in memory, returning along with the MBT 40 results a data structure for the output 52 that can characterize memory occupancy. For example, a 10 bit input frame requires a 1024 bytes. A 1024 element bitmap can indicate 1 when the corresponding byte of memory is used and 0 when it is unused. A complete bitmap requires 1024 bits or 1024/8=128 bytes of memory management overhead.

Since MBT 40 tends to be used up in blocks, instead of one bit for each byte of MBT 40 memory that has been used, there could be less overhead by assigning one bit to each defined nibble (of 4 bits), thus MBT 40 usage can be defined in contiguous blocks of 2⁴=16 bytes, resulting in only 8 bytes of management overhead, each bit of which indicates whether contiguous groups of 16 MBT 40 memory locations are in use or not. Every such memory group containing an entry in the memory usage bitmap of 0 could be written into by the signal generator 22 during its clock cycles. This can continuously purge all such memory locations so that there can be no residual record of sensitive transient data such as salaries. Also there can be a deletion of any ISA proprietary information transient through the MBT 40. When the memory usage bitmap is all zeros, there can be a continuous erasing of all data via patterns equivalent to commercial memory wiping software tools. This continuous wiping operation is not optional and tamper detection includes detecting tampering with the memory usage bitmap.

In the absence of noise cancellation, the MBT 40 can add cryptographically generated bits from its signal generator 22 to the contents of the MBT 40 memory, e.g., according to a scheme embedded into the signal generator 22 hardware, either directly or as mediated by the memory usage bitmap discussed above, that cannot be altered by access, reprogramming, or hardware maintenance. Tamper detection can cause aggressive anti-tamper action, such as, the writing of random bits into the MBT 40 lookup table until the embedded power source(s) 32 is exhausted. When the embedded power source(s) 32 reaches a predefined minimum capacity, the signal generator 22 can initiate such anti-tamper action. Anti-tamper action can be further mediated by input interface 50 filtering and by audit trails, e.g. via cooperation of multiple PEs 20. If multiple PEs 20 are not available for tamper mitigation, then all PEs 20 can, e.g., destroy themselves autonomously via the processes of embodiments of the disclosed subject matter.

The TBS PRFs include the GRFs without unbounded loops of any sort, including external very low speed loops that may be synthesized via persistent memory and that may be synthesized via malicious users or malicious agents in an external network. Therefore, the PRF-ISA according to aspects of embodiments of the disclosed subject matter can eliminate data persistence by regularly adding cryptographically generated noise to the data and to the ISA level functions of the system 1000. In this way. after a short, finite time, all data and functionality can be eroded beyond data repair before the loss of internal power sources that assure data erosion via MBT 40 memory wiping.

When external and internal streams are not actively canceling each other, the addition of the bitstream from the signal generator 22 to the memory of the MBT 40 adds cryptographically generated noise based on the URS 54 to the contents of MBT 40 memory. Since the MBT 40 memory defines processing, this noise causes capability to be eroded. After some number of such cycles of adding noise to MBT memory, the ISA cell powers itself down completely, leaving only the long random number of the unique random signature (URS) as the remaining information of the PE 20. When it is not desired to modify or eliminate the data in the MFT 40 memory, the cross-correlators, receiving signal generator output through the connections 1, can subtract the same bits from the MBT 40 as are being added from the signal generator 22, and thereby cancel the modification of the MBT 40 content.

With the URS 54 of the PE 20 and the related timing information from audit trails, data in the MBT 40 memory may be recovered via cryptographic procedures to regenerate the structured noise in the order in which it was imparted. This can recover MBT 40 memory through the non-linear processes involved and reverse the application of the noise. In the preferred embodiment, the URS 54 itself is destroyed when the PE 20 is removed from the system.

Although computationally intensive and requiring the URS 54, these procedures can employ well known commercial cryptography and thus do not advance the state of the art of cryptography per se. The size of the URS 54 and the structure of timing, RAND, signing function A(*), and SRES can be designed to be smaller or larger, to enhance hardware, power or computational efficiency, or to mitigate brute force cryptanalytic attacks within practical space-time constraints for a long time. However with knowledge of the URS 54, RAND, SRES and A(*) and related metadata in the system descriptors of the COP, the MBT data that has been obfuscated may be recovered in a relatively short, finite time. Noise cancellation functional blocks, 200 in the IPCell 700 of FIG. 4, can overcome data obfuscation by the real-time cancellation of cryptographically generated noise. These functional blocks 200 can achieve at the macro scale for the IPCell 700 the mitigation of system noise, comparable to what the signal generator 22, cross-correlators 24, and MBT 40 accomplish internally to each PE 20.

PRF ISA PE 20 and M 80 functional blocks 970, such as are shown in FIG. 2, may synthesize noise-cancellation functionality. URNs 54 of FIG. 3 of a length required to optimize the system 1000 FIG. 1 tradeoffs may be created at the factory for the ISC2 system 1000 and assigned systematically according to the system identifiers of the factory COP as subsequences of extreme scale pseudo noise (XPN) sequences. Extreme scale pseudo-noise sequences are PN sequences with very long lengths. As an example, as is well known in the art, a 359 digit number, where, 359 is itself a prime number, can be used to generate a sequence G(p), a maximal length sequence, where the size, IG(p)|, of G(p) equals 2^{P}−1, which exceeds the extreme sequence length indicated above.

Codes can be generated based on some seed s, e.g. the 359-bit number, p, with some relatively large increment, K>>p, between codes assigned so that there is no cyclic redundancy among URNs in a fabric of 1018111 such clusters. Each cluster can retain its own URN plus those of k adjacent clusters, typically four to eight, depending on the order of the exascale fabric, which is the number of clusters that are immediately adjacent to each other such cluster. Adjacency can include physical proximity (e.g. 4 nearest neighbors) and electronic proximity (e.g. connected via direct fiber optic path to points in the fabric that are remote).

When randomly challenged, the PE 20 can apply its signature function A(*) to its own seed, while adjacent clusters of PEs 20 can authenticate adjacent PEs 20 by applying A(*) to the URN computed from the PEs 20 own seed plus the increment K and the PE's 20 own ability to generate. Noise cancellation provides a cryptographically manipulated stream of the p-sequence via A(*) to the cross-correlator 24.

Information transformation (IT) functional blocks 300 in the IPCells 700 can be PRF ISAs configured to transform data on an input as a function of input and IPCell 700 state, into output data. IT 300 may operate analogously to IR functional blocks 100, in particular, inducing atrophy of MBT 40 functionality unless cancelled by atrophy cancellation functional blocks 400, e.g., in the manner discussed above regarding signal generators 22 and cross-correlators 24 in the PEs 20. IT functional blocks 300 may represent transformations compactly, such as representing 8 bit arithmetic via a conventional arithmetic processing element versus a 2×16 word (64 million word) lookup table. A large embedded lookup table (16 MB for two 8 bit operands) is an exemplary embodiment, however, because of its inherent flexibility to represent any defined 8×8 function, with conventional arithmetic as a near-term stopgap to overcome memory hardware limitations.

IT functional blocks 300 may encode state dependencies in their associative memories. The minimum number of frames in an IT 300 work cycle is N=four. Input-frame decryption, MBT 40 lookup, and output 52 encryption in the SAOS may allocate packet frames per work cycle that reflect the processing needs of applications, N>4. MBTs 40 may transform the type of packet flowing from an input 50 to an output 52. Packet type may be defined by a data subset of the packet, e.g., a frame of the packet, that originates with the user or that is learned by the system 1000. Packet types may be represented as conjoined data elements or more compactly as an index or label with respect to a reference data object. PRF ISA's may synthesize atrophy-cancellation through atrophy cancellation functional blocks 400 in a manner analogous to noise-cancellation.

The number of active external support systems for normal operations and for sleep operations (in which autonomous reprogramming can be accomplished and for externally defined reconfiguration may be accomplished) is not the same. Normal operations require the support of at least one external support system communicating with the PRF ISA in every work cycle, e.g., via a cross-correlating channel. Sleep operations require at least two such external support systems. Reconfiguration operations require at least five such external support systems. These parameters may be synthesized in the MBT 40, prohibiting, for example, the reloading of MBT 40 with fewer than five external support systems.

The input/output interfaces 500 of an IPCell 700 may encapsulate a set of information processing elements 20 into the IPCell 700, e.g., bounded by the input/output interfaces 500. The input/output interfaces 500 can be TBS PRF-ISA PEs 20 configured, e.g., to alter signal generators 22 and cross-correlators 24 to make it impossible for physically adjacent PEs 20 to interact logically or physically, such as by powering down correlators 24 that service particular inter-cluster communications channels in a way that only the input/output interface 500 can power them on again. Input/output interfaces 500 are unidirectional, allowing data to enter or exit an IPCell 700. Two input/output interfaces 500 may cooperate to synthesize a unidirectional (U) IPCell 700 where data packets can flow into one input/output interface 500, e.g., on the left in FIG. 4, can be transformed in the IPCell 700, and exit the other input/output interface 500 on the right in FIG. 4.

Multiple input/output interfaces 500 may collaborate to synthesize more complex IPCells 700, such as multi-output (MO) IPCells, multi-input (MI) IPCells, multi-input-multi-output (MIMO) IPCells 700, pyramidal IPCells 700 (that establish 3D patterns of data flow for functional and/or self-monitoring purposes) and mirror IPCells 700 (that establish data flows so that one part of the system can monitor or assist another, such as a mirror cell flow from the time card IPOverlay 954 to an Audit IPOverlay (not shown) that aggregates amounts from paychecks issued in a given week against original time card data, taxes, etc.

These may be organized to facilitate internal audit, reporting to government agencies, etc. These IPCell 700 structures may still have single or multiple IR functional blocks 100 organized in serial, parallel, or hybrid arrangements, single or multiple IT 300 functional blocks, etc. Inputs/outputs 500 may be specifically configured to audit the flows through the IPCell 700, while they are tasked by the system identifiers of the IPCell's 700 COP to collaborate to monitor the established interface parameters of PE clusters forming the functional blocks, e.g., 100, 200, 300, 400 internal to the IP Cell 700 that, e.g., deliver data via the interfaces 500. The IPCell 700 can distribute its workload among the interior functional blocks 100, 200, 300, 400 of FIG. 4 which also are suggested at 970 of FIG. 2. The PE 20 and M 80 functions, e.g., which can support the IR 100 and IT 300 functions of the IPCell 700 as configured into multiple IRs 100 and/or ITs and other cell functional blocks 200, 400, and COP. The PEs 20 can self-monitor, but the PEs 20 organized into functional blocks 100, 200, 300, 400, 500, 600, along with the COP blocks may form the lowest layer element in which complete independent self-referentially consistent self-awareness is synthesized (because of the use of the COP throughout the IPCell 700). This can be achieved by the design of the disclosed subject matter to synthesize the IPCell 700.

IPCells 700 can maintain a unidirectional flow among input/output interfaces 500, from input functional block 500 on the left of the IPCell 700 to output functional block 500 on the right of the IPCell 700 as shown in FIG. 4. These input/output interfaces 500 can access all interface functional block s 500 and supporting functional blocks 200, 400 within the IPCell 700 and in interface monitor functional blocks 600 between the IPCells 700 (termed interstitial space) to compactly represent and maintain at these access points a summary of flows inside the IPCell 700 so that the IPCell 700 functions may be assessed for consistency with respect to the COP, internally to the IPCell 700 and so that they may be orchestrated by the IPOverlay 950 of which they are a part via the TBS PRF ISA and VM.

The input/output functional blocks 500 can mediate interactions between different IPCells 700. In particular, an input 500 may split information from an upstream IPCell 700 output 500, which may be a reference IPCell 700, into multiple flows, either external or internal or both as a function of input 500 and the state of the interface monitor functional blocks 600 between the various IPCells 700. A data frame in an input functional block 500, may consist of, for example, output data frames from several PEs 20, that are associated such association may be, e.g., in the same way that the PEs 120a and 120c of FIG. 7 comprise a name through the association of (last) with (first). Such PEs 20 may deliver a thing (name (last) (first)) to the boundary of an IPCell 700 by connection to a pair of PEs 20 in the interface functional block 500 established for this purpose by the containing IPCell 700, e.g., according to the system identifiers of the COP.

An input/output 500 may split information into divergent streams, such as by connection to a flow of (name(first)) in one processing flow (such as to establish a collection of first names for a corporation using the ISC2 system 1000) and to a second flow, e.g. of (name(last)) a flow that might include employee identification numbers, e.g. to check for parking permits. The input/output 500 may replicate the reference frame (name(last)(first) or a subset of the frame (name(first)), or may differentially access and forward subsets of the reference frame, such as the first two characters of the (name(last)) used on a parking permit, and may append additional information to the data extracted from the reference frame (such as employee identification number) before forwarding the aggregate data frame to its own output functional block 500 in the IPCell 700.

Output 500 directed externally may impinge on other IPCells 700. Inputs 500 directed internally can extend the IPCell 700 flow to internal functional blocks, such as, to IR functional blocks 100, or internal monitor functional blocks 200 or 400, e.g., via the arrows shown in FIG. 4. The functional blocks, such as, 800 of FIG. 2, can express the physical organization of PE 20 and M 80 functions, while the IR 100 and IT 300 flows through the cell via single or multiple IR functional blocks 100 and/or sungle or multiple ITs functional blocks 300 shown in FIG. 4, constituting linear flows.

Data flow functions may be mediated by MBTs 40 within PEs 20 forming a part of the input/output 500 PRF ISA functional block(s). The functional block 970 of FIG. 2 represent the physical clustering of PE 20 and memory M 80 functions, while the IR functional blocks 100 and IT functional blocks 300 represent the logical flows. Logical flows may be realized via a simple stream of PEs 20 or more typically via multiple IRs 100 and/or ITs 300. These data flow functions can synthesize indexing, if-then, iterate N, and finite choice functions that are primitive recursive. The structure of the MBTs 40 and the flows through IPCells 700 via IRs 100, ITs 300, and IR 100 with oversight of functional blocks 200 and 400 via the COP entail sequences of flows through their constituent PEs 20 with flows through their constituent MBTs 40 to synthesize these tightly constrained PRFs.

The repeat-N loops are synthesized linearly by unwrapping loops into physically distinct PEs 20, IPCells 700, and/or IPOverlays 950, depending on the nature of the information processing task(s). For example, a loop that iterates for I=1 to 3 to perform some function F( ) on some array X can be expressed as a loop For I=1:3 F(X(I)) END to iterate as a loop, or it may be unwrapped into the system descriptor COP form as a path {/F(X(1))\/F(X(2))\/F(X(3))\} where the MBT 40 Input/outputs 500 may not allow loops within an IPCell 700 but do allow such pipelines.

Attempts to form loops are detected by monitor PEs 20 in the lowest level functional blocks, such as 970 of FIG. 2, medium level IPCell 700 monitor functional blocks 200 and 400 and higher level OPOverlay 960 functional blocks 700 and 800. The repetition of any (thing) in a flow may be detected by a monitor PE 20 of a lowest level cluster of PEs 20, such as in functional block 970 of FIG. 2, and reported as the path {(thing1) . . . (thing1)} to the IPCell 700, which may authenticate the pattern via its local copy of the COP. The monitor PE 20 may refer the pattern as an exception via flow monitor functional blocks 600 to the IPOverlay 950. the IPOverlay may resolve the alert via its greater analytical processing abilities of specialized IPCells 700, such as mirror or loop analysis functions realized via such IPCells 700 within the IPOverlay 950.

Patterns not resolved may be transformed from alerts to alarms, e.g, to multiple human beings 970 and 972 representing responsible parties or to the factory. Logging of such loop anomalies and other alerts may occur at the IPCell 700 level in the MBTs 40 of PEs 20 of monitor functional blocks 200 and/or 400. Logging of alerts can be achieved at the IPOverlay 950 level via specialized IPCells 700 or by monitor functional blocks 800 or a combination of both.

During periods of low rates of appearance of (things) at the IPOverlay 950 interfaces 900, or external IPCell 700 interfaces 500, particularly when such periods are predictable, the ISC2 system 1000 may autonomously employ a fraction of its resources. This may be as specified in the COP to autonomously analyze its own history to determine changes to its own IPOverlays 950, IPCells 700, and/or the arrangements of physical and functional PE 20 clusters such as in functional block 970 that would optimize a given fitness function, which is a mathematical expression of what to optimize. Fitness functions are well known in the art of genetic algorithms and genetic programming which are specialties of ML applicable to the ISC2 system 1000.

Periods during which temporarily available computations and computing resources are available for such autonomous introspection may be termed sleep cycles. During sleep cycles, a system 1000 may split some cells by allocating additional PEs 20 and causing the IPOverlay 950 to interpret the COP such that splitting occurs without loss of existing data. Other IPCells 700 that may be underutilized may be consolidated via data migration (controlled by the IPOverlay 950). such data migration may move data via inputs/outputs 50, 52 in PEs 20, input/output interfaces 500 in IPCells 700, and via interstitial functional blocks 600 and 400, so that an IPCell 700 may be disassociated, liberating its constituent PEs 20 to be reused elsewhere in the system 1000.

Each information processing system (IPS) 1000, which may constitute a grouping of IPOverlays 950 has capabilities and limitations defined in a System 1000 COP, the collection of all system identifiers employed in system 1000. The COP can define how to form IPOverlays 950 out of IPCells 700 with particular capabilities and connectivity. Each IPCell 700 can contain a complete copy of the system identifiers referred to in aggregate as the COP, e.g. in the IPCell 700 functional blocks labeled as COP in FIG. 4. Specific (things) may provide pointers (COP pointers) into the complete COP in the IPCell 700 whereby such (things) can act as indices to designate to an IPCell 700 where it fits within the larger IPOverlay 950 and its specific role within such host IPOverlay 950.

IPCell 700 input/output interfaces 500 can collaborate with each other by sharing data (things) such as (COP pointers) with adjacent IPCells 700 on the basis of the embedded COP as a system 1000 blueprint. Each IPCell 700 can continuously monitor its connections and external environment to verify successful functioning during non-sleep operations which also may be termed work cycles. When disparities are detected, the IPCell 700 can take action to minimize the disparity in order to maximize IPOverlay 950 effectiveness, and when ordered to and with sufficient multiple attestation from IPOverlays 950 and from independent PEs 20, may destroy itself if necessary when it encounters unrecoverable errors. Alternatively, when permitted by the COP, such an IPCell 700 may take on the role of an adjacent IPCell 700 to assist that IPCell 700, or to support IPOverlay 950 and system 1000 resiliency when such an adjacent IPCell 700 destroys itself. Such local restructuring behaviors are enabled and suppressed for hardware, VM, and applications things and for computational support to people and enterprise policies 150 as specified in the COP.

Real-time audit trails accrete data needed to assure completeness and consistency of the system 1000 with respect to the COP. Sleep cycles allow for the digestion of audit trails to enhance the system 1000 via adjustments to IPOverlays 950, IPCells 700, and other clusters of PEs 20 within and between such IPCells 700 and overlays 950. The autonomous digestion and analysis of its own audit trails may extend input/output interfaces 500, 900 via trust envelopes.

A trust envelope is an interlocking set of hardware 82, software 158-162, applications 156, people 154, and policies 152 and 150 with which the system 1000 has accumulated sufficient positive history over months or years specified in the COP as thresholds for such trust. Trust envelopes may be extended to new people, communications paths, policies, and to new hardware component parts of an evolving system 1000 consistent with assimilation parameters of the COP. Such trust envelopes must be coincident with the scope of each input/output interface 500 and with the associated system 1000 boundaries 900. Extension of trust envelopes during sleep cycles is allowed in order to enhance wake cycle scope (e.g. adding new people to be supported by the system), effectiveness (e.g. adding new applications), and performance (e.g. adding new hardware), to support behavior extension, and to otherwise manage the information processing flows and connectivity among people and the system 1000.

IPCs 700 can aggressively preclude looping but can provide finite iteration via loop unwrapping as previously discussed. During sleep cycles, PEs 20 may be accreted by the systematic movement of input/output interfaces 500 and other IPCell 700 boundary PEs 20 into the space between IPCells 700, e.g., to provide additional computational resources.

Input/outputs 500 can define the work cycles for each PRF ISA by specifying the number and type of IP data input frames accepted per second, per unit time, and/or per work cycle, e.g., as the constraints of the COP are instantiated in the IPCell 700, as well as by distributing those parameters to the IPCells 700 during sleep cycles. Loop detection can cause cyclic graphs (graphs with loops) to be transformed during sleep cycles into paired acyclic graphs, which are graphs that are unidirectional, but where two different graphs interface via a graph interface point.

Specifically, a cyclic graph with and arrow 1 via IPCell 1 from input A to output B (an input or output point A or B, then, is called a node of the graph, and an arrow is called an arc), and with an arrow 2 of the graph via IPCell 2 from node B to A node is a cyclic graph. This cyclic graph may be split into two distinct acyclic graphs (graphs with no cycles), one with nodes A and B1 and a second graph with nodes B2 and A. The graph (A, B1) would be managed by, for example, an IPOverlay I, while the graph (B2, A) would be managed by an IPOverlay II. The movement of data between B1 of IPOverlay I and B2 of IPOverlay II would be mediated by overlay interface points 900 monitored by overlay interface monitoring functional blocks 800.

The movement of (data) from B1 to B2 would provide time delay and verification that the iterative behavior defined across the path {A, B1, B2, A} is primitive recursive, tightly bounded, and consistent with the COP. For example, one may compute all of the integers out to infinity by the successor function s(x)=x+1. If IPCells 2 and 2 each provide a successor function s( ), then A may be the even numbers beginning with zero, 0, and B may be the odd numbers. The COP specifies that no integer in a system 1000 may exceed some specified maximum, such as 15647222, which is the number of cents in the maximum salary that can be paid to an employee of this company. All other integers are less.

The interface between IPOverlays I and II assures that as s(x) is computed, the result is compared with 15647222 and if a number greater than this maximum is generated, then the alert is raised to the COP, which indicates that this limit may be raised by mutual agreement among certain people. The limit of 1000000000000, would violate this constraint so severely that its implementation would require consent of the factory. Otherwise, the system would preclude increasing this limit.

The IPS 1000, its internal IPOverlays 950 and its constituent IPCells 700 may update the system 1000 COP and may transmit COP updates to groups of IPOverlays and to IPCells 700 during sleep cycles. COP updates may require verification by human operators, administrators, and managers of the system 1000 before updates are implemented via proliferation of the COP to all of the IPCells 700 of the system.

The IPS 1000, can include a plurality of people, equipment, media, and communications mechanisms that detect, communicate, transform, and respond to physical representations of information, whether analog or digital, whether chemical, mechanical, electromagnetic, electronic, virtual, or combinations of these. The system 1000 COP blueprint can index all physical and virtual systems components, many of which may be encapsulated in COP expressions previously employed in the disclosed subject matter as examples, and referred to from time to time as models of the things, places, paths, actions, and causes that people deal with.

For example, the thing (pay check) is not an actual pay check, which is a piece of paper, but is a computational model of the pay check that contains the data that would be appropriate for the physical pay check that is being modeled, such as the amount of the check, date, and payee. Physical properties such as a watermark may be modeled so that the system can employ its video sensors at the point of printing the checks to be sure that the watermarked paper is being used during check printing. Other properties such as the authorizing signature may be modeled, but an actual signature from a specified human being may be necessary to complete the instantiation of a physical check.

An IPS 1000 can evolve to become a collection of IPOverlays 950 with unique types of input/output interfaces 500 in their respective IPCells 700, for those IPOverlays 950 that are directly controlled by and within the IPS 1000, for those IPOverlays 950 that are indirectly or imprecisely controlled (e.g. a physical system such as an aircraft or manufacturing machine), for those IPOverlays 950 that are directly influenced via a known causal model (e.g. people who are part of the system), and for those IPOverlays 950 whose direct or indirect information influences are not modeled (e.g. the rest of the universe outside of the thing that is being physically observed and controlled). Fidelity of representations of the nature, structure, and function of these various classes of IPOverlays can vary substantially depending on degree of control and on the existence and fidelity of models.

IPOverlays 950 can originate, transform, and/or absorb information. The disclosed subject matter can entail multiple realizations of IPOverlays 950. IPOs 950 can consist entirely of IPCells 700 that consist entirely of internal PRF ISA functional blocks, such as 100, 200, 300, 400, 500, 600, e.g., encapsulated within self-awareness envelope, i.e., the PE's 20 between input and output interfaces 500. The IPOverlays 950 can be complete, consistent, and controllable (C3). IPOs 950 can be complete with respect to finite arithmetic because the PRF ISA clusters 100, 200, 300, 400, 500, 600 can synthesize tightly bounded subsets (TBS) of the primitive recursive functions (“PRFs”) in their PEs 20. This can also be because the input/output interfaces 500 can monitor internal IPCell 700 structures by examining the structure and content of (things) transiting the interface 500, Dedicated monitor functional blocks 200 and 400 can examine the structure and content of (things) on the inputs 50 and outputs 52 of PEs 20 of the functional blocks, such as, IRs 100 and ITs 300.

During wake cycles, this monitoring can form audit trails which are digested and analyzed to sustain completeness and consistency via audit processing during sleep cycles. Since the number of data packet frames processed during a work cycle is controlled by the IPCell 700, there is no computational task that does not have a tightly bounded space-time-bandwidth resource envelope according to which to function. IPOverlays 950 can distribute IPCell 700 functions to multiple functional blocks 100, 200, 300, 400, 500, 600, e.g., by configuring functional blocks 100 with PEs 20 to represent information as illustrated in detail in FIG. 7 and configuring functional blocks 300 with PEs 20 to transform information as illustrated in detail in FIG. 8, wherein some PEs 20 of each such functional block 100, 300 can be configured specifically for the monitoring of structure and contents of (things) flowing in the resulting parallel pipelines and resulting in the detection of any malfunctioning functional blocks 100, 200, 300, 400, 500, 600. This monitoring forms a basis for PE 20 dissolution and recovery without damaging IPCell 700 functioning. Groupings of IPOs 950 can distribute the cognitive workload to IPCs 700, thus organizing IPCs 700 into mutually supporting IPCs 700. IPCs 700 within a given IPO 950 can share the identity of the IPO 950 into which they have been assimilated.

Information transits input/output interfaces 900 for IPOverlays 950. IPOverlay 950 input/outputs 900 can comprise collections of IPCs 700 organized to detect the presence of information external to the input/output interface 900 with sufficient physical and logical proximity to be observed within the IPOverlay 950 and if appropriate to generate an IPO 950 response. For example, a free space optics (FSO) path between a sensor system (not shown) and a receiving IPOverlay 950 can provide data to the IPOverlay 950, subject to successful transition of the FSO input/output (not shown). The IPO 950 may ignore the data from the FSO without injuring itself, and the free space path can provide physical and electrical isolation of the IPO 950 that may be beneficial, e.g. from a security perspective by limiting the radiation of information compared to radi transmission for example.

Particular types of IPOs 950 may interact with the physical environment in ways specified in terms of space-time x mass energy domain behaviors that are independently monitored by multiple IPOs 950, such as physical systems under control like an automobile or airplane into which the ISC2 system 1000 is embedded.

Computing and communications systems not cryptographically assured to be C3 IPOverlays 950 such as described herein, may be treated by the IPS 1000 as uncontrollable IPOs 950. People are uncontrollable organisms with which can be associated the distinguished property “human.” People, plants, and animals share the distinguished property “living.” All other forms of matter share the property “inanimate.” IPSs 1000 that include only C3 IPOs 950 and people acting as operators according to aspects of embodiments of the disclosed subject matter, in an exemplary embodiment thereof, can evidence constituent C3 IPOs 950 of such an IPS 1000 that can collectively constitute an ISC2 system 1000 embodiment.

People have unique identities. ISC2 IPSs 1000 can model people throughout human processes in order to provide multiple independent indications regarding the identities and roles of people with whom the system 1000 can interact. People can be modeled with a large array of biometrics across the range from face, voice, gait, and other physical behavior (soft biometrics) to fingerprint, iris, retina, DNA, and other strongly unique measurable features (hard biometrics), as well as possession of tokens such as identity cards (physical tokens) and passwords (virtual or information-space tokens).

For the ISC2 system 1000, people are not organized into hierarchical classes, but into networks. People can obtain privileges for interacting with IPS 1000, e.g., through cryptographically assured means, or via machine learning with cryptographically assured validation from a well-known authority. Role-based access controls (RBAC) can define duties for people for specific security-related activities so that no one person can compromise a system e.g. by writing fraudulent checks to a non-existent vendor, receiving nonexistent goods, and cashing the checks to embezzle from the company.

Privilege-based controls can associate authorities with the tasks of each unique person and with the associated IPO 950 tasks of the IPS 1000. An authority therefore can be formulated as the association [(Person (Task), IPO(Task), LCP (“Task))*J], giving a person the authority to perform the specified IPO 1000 task at the associated LCP, where [ ] is the transitive closure operator and * is the Kleene star operator generating all possible associations, which may be very large. Privilege may be established autonomously by an IPS 1000 based on responsibilities of the person in a given context (e.g., LCP task), e.g. for the duration of the task in order to achieve task effectiveness. Such a privilege model can transform role-based security where the system lacks a comprehensive model of the people, tasks, and functional relationships into a clearly bounded sub-space within a comprehensive model of the IPS 1000 Self and the people interacting with it.

The ISC2 1000 operating system (OS) can transform computer program applications into C3 IPOs 950, which can then be transformed into IPCells 700 and PRF ISA sequences, such as IPO 950 functional blocks 100, 200, 300, 400, 500, 600, 700, 800 and 900. Given an application coded in a conventional programming language such as a chess game in C or a signal processing application like GNU Radio, the ISC2 1000 OS can analyze the scope of the application and map it into IPOs 950, IPCells 700, and sequences, such as IPO 950 functional blocks 100, 200, 300, 400, 500, 600, 700, 800 and 900, without internal loops.

In the example of a chess game play application, board position pointers can allow direct access of the IPS 1000 to the current board position, legal moves, and search forward from that board position in order to formulate the next move output from the system 1000. In a GNU radio application, streams from analog to digital converters (ADC) at antennas can be transformed by IPOs 950 that provide spectrum occupancy estimation, space-time signal isolation, filtering, equalization, data stream extraction, forward error control, and media form conversion, delivering the communicated signal to the user in real time. The ISC2 OS can organize IPOs and IPCells to optimize mission mix, e.g. via genetic programming during sleep cycles, learning from experience.

The systems level realization of the PRF principles, in an ISC2 system 1000 self-aware operating system, internal and external communications-awareness, applications-awareness, and user-awareness can lead to the realization of a provably secure self-aware operating system (Psec SAOS). The ISC2 system 1000, therefore, can realize applications development environments that appear to computer programmers to consist of well known software tools such as Matlab, Ruby, C, Perl, Python, etc., and with well known operating systems abstractions such as external devices and file systems, but that realize the underlying computing and communications strictly via a PRF-ISA system 1000.

Via the PRF-ISA system 1000, an information representation functional block 100, an information transformation functional block 300, and input/output interfaces 500 may be synthesized in hardware via a multiplicity of embodiments including identical stacked associative memories where unique firmware instantiations differentiate functions and where instantiations may be migrated from one ISA module to another.

In an example of an embodiment of a PRF ISA system 1000, there can be no need for instructions per se, nor op-codes, but only data associations that yield defined results in a single step, functionally utilizing, e.g., a table lookup. For example (“1+1=2”) and (+, 1, 1, 2) both may be partitioned into [X001, X001, ‘+’]=>[X010], the table lookup version of the binary addition of one plus one equals two. The symbol ‘+’ is not an opcode, but rather is a data association where the data, e.g., in the form of hex 001, hex 001 and ‘+’ yield 010, “1+1=2”. Similarly, “2>1=>TRUE” can encode part of an inequality. In MBT 40 computing, compactness of the representation is not as important as the flexibility of the learning-cycles. During a learning cycle, a new opcode may be defined by a set of entries into an MBT 40 lookup table, with learning and MBT 40 update mediated by the provably secure self aware operating system (Psec SAOS).

It will be understood by those skilled in the art that the disclosed subject matter of the present application utilizing system identifiers within a VM can provide a system identifier metaphor, namely that given a (thing), another (thing) may be induced by changing some aspect of one of the [place], {path}, <action>, or <cause> roles, e.g., via the metaphor action /meta\, such as /meta{(reference thing) (new thing [identical][novel])}\.

In such a /meta\ action the reference thing can remain the same through the induced thing bindings [identical] and [novel]. The new thing behavior may be induced from the reference thing for bottom-up inheritance, such as the inference that (highways) have widths >10 feet, from the fact that one (asphalt) highway is >10 feet wide, one (dirt road) had a width >10 feet, and that one (superhighway) had width >40 feet. The thing (highway) aggregates all of these examples into a new derived thing (highway [width (>10 ft)]) in COP notation. This bottom up inference by aggregation and simplification can be applied to any(thing) (places, paths, actions, and causes) as well as to things subject to system identifiers.

It will also be understood that things all are indexed by the system 1000 architecture. Empty space and unused PEs can be indexed by the system 1000 architecture, e.g., constantly destroying their own contents. With all infinite or loosely bounded loops, such as While, Until, and related For loops being prohibited, the prohibition can also be verified such as at the levels of the IPCell 700, IPOverlay 950 and groupings of IPOverlays 950, e.g., via the just noted metaphor bindings.

The IPEs 20, IPcells 700, IPOverlays 950, and groupings of IPOverlays 950 can verify conformance, e.g., to tight space-time-bandwidth limits. Also it should be recognized that for IPCell 700 operation there is a processing flow whereby the information representation functional blocks 100 can acquire the input data (things) to the IPCell 700, from input/output interface 500 at the left of FIG. 4. With no hard drive in use, the data is always “in motion” from input to output, buffered in the IRCs 100 and once determined to be proper, e.g., to conform to the system identifiers for the particular IPCell 700, then passed on to and processed with an information transformation functional block 300 with results then buffered in a second IRC 100 on the right of FIG. 4 for transfer to the output 500 of the IPCell 700 on the right of the IPCell 700. Flow is unidirectional within each IPCell 700 and IPOverlay 950.

It should be understood that the embodiments described herein are merely exemplary and that a person skilled in the art may make many variations and modifications without departing from the spirit and scope of the invention. All such variations and modifications are intended to be included within the scope of the invention.

I claim:

1. A computing and communications method comprising:
utilizing a primitive recursive function computing engine including an instruction set architecture prohibiting loop operations that continue for an indefinite time to perform computing functions.

2. The computing and communications method of claim 1 wherein the instruction set architecture comprises utilizing system identifiers selected from a group comprising things, places, paths, actions and causes.

3. The computing and communications method of claim 2 wherein the instruction set architecture comprises organizing at least one data thing into a processing path to be acted upon by an action.

4. The computing and communications method of claim 3 wherein the instruction set architecture comprises defining a processing element as comprising:
an input interface configured to receive a data thing into the processing path;
a processor in the processing path configured to perform the action on the data thing; and
an output interface configured to receive a result of performing of the action on the data thing configured to provide the result as an output of the processing element.

5. The computing and communications method of claim 4 wherein the instruction set architecture comprises defining an information processing cells utilizing a plurality of processing elements.

6. The computing and communications method of claim 3 wherein the processing path is uni-directional.

7. The computing and communications method of claim 5 wherein the instruction set architecture comprises organizing the processing cells into a parallel pipelined arrangement.

8. The computing and communications method of claim 4 wherein the processor comprises a memory based transformation unit.

9. The computing and communications method of claim 8 wherein the memory based transformation unit comprises a lookup table accessed according to the content of the data thing.

10. The computing and communications method of claim 9 wherein the instruction set architecture further comprising utilizing a compact markup notation to define the roles of things, including notations including enclosing the type of thing within symbols defining the role of the thing.

11. The computing and communications method of claim 10 wherein the notations comprise (thing), [place], {path}, /action\ and <cause>.

12. A computing and communications system comprising:
a primitive recursive function computing engine including an instruction set architecture prohibiting loop operations that continue for an indefinite time.

13. The computing and communications system of claim 12 wherein the instruction set architecture comprises system identifiers selected from a group comprising things, places, paths, actions and causes.

14. The computing and communications system of claim 13 wherein the instruction set architecture organizes at least one data thing into a processing path to be acted upon by an action.

15. The computing and communications method of claim 14 wherein the instruction set architecture comprises a defined a processing element comprising:
an input interface configured to receive a data thing into the processing path;
a processor in the processing path configured to perform the action on the data thing; and
an output interface configured to receive a result of performing of the action on the data thing configured to provide the result as an output of the processing element.

16. The computing and communications system of claim 15 wherein the instruction set architecture comprises a defined information processing cell comprising a plurality of processing elements.

17. The computing and communications system of claim 14 wherein the processing path is uni-directional.

18. The computing and communications system of claim 16 wherein the instruction set architecture comprises organizing the processing cells into a parallel pipelined arrangement.
organize data things and processing paths and actions

19. The computing and communications system of claim 15 wherein the processor comprises a memory based transformation unit.

20. The computing and communications method of claim 19 wherein the memory based transformation unit comprises a lookup table accessed according to the content of the data thing.
